(19) United States
(12) Patent Application Publication
(10) Pub. No.: US 2022/0259398 A1
(43) Pub. Date: Aug. 18, 2022

(54) (CO)POLYMER MATRIX COMPOSITES COMPRISING THERMALLY-CONDUCTIVE PARTICLES AND MAGNETIC PARTICLES AND METHODS OF MAKING THE SAME

(71) Applicant: 3M INNOVATIVE PROPERTIES COMPANY, St. Paul, MN (US)

(72) Inventors: Sebastian Goris, Inver Grove Heights, MN (US); Derek J. Dehn, Maplewood, MN (US); Paul T. Hines, St. Paul, MN (US); Michael S. Graff, JR., Woodbury, MN (US); Mario A. Perez, Burnsville, MN (US); Charles L. Bruzzone, Woodbury, MN (US); Bharat R. Acharya, Woodbury, MN (US); Clinton P. Waller, White Bear Lake, MN (US)

(21) Appl. No.: 17/595,094

(22) PCT Filed: May 9, 2020
(86) PCT No.: PCT/IB2020/054402

§ 371 Date: Nov. 9, 2021

Related U.S. Application Data
(60) Provisional application No. 62/848,418, filed on May 15, 2019.

(51) Int. Cl. C08J 9/28; C08K 3/38; C08K 3/08; C08J 3/21; C08J 9/00; C09K 5/14; H01F 1/053

(52) U.S. Cl. CPC C08J 9/283; C08K 3/38; C08K 3/08; C08J 3/212; C08J 9/0066; C09K 5/14; C08J 2201/0522; C08K 2201/001; C08K 2201/01; C08K 2003/385; C08K 2003/0856; C08J 2323/06; C08J 2383/04; H01F 1/0533

(57) ABSTRACT

(Co)polymer matrix composites including a porous (co)polymeric network; a multiplicity of thermally-conductive particles and a multiplicity of magnetic particles distributed within the (co)polymeric network structure; wherein the thermally-conductive particles, magnetic particles and optional magnetic particles are present in a range from 15 to 99 weight percent, based on the total weight of the particles and the (co)polymer (excluding the solvent). Methods of making and using the (co)polymer matrix composites are also disclosed. The (co)polymer matrix composites are useful, for example, as heat dissipating or heat absorbing thermal interface materials that also provide magnetic properties useful, for example, in flux field directional materials or shielding from electromagnetic interference.

### BACKGROUND

Integrated circuits, active and passive components, optical disk drives, batteries, motors, for example, generate heat during normal use. To prolong the long term, as well as continuous, use of the devices, the generated heat is dissipated. Finned metal blocks and heat spreaders containing heat pipes are commonly used as heat sinks to dissipate the heat generated by devices during normal use. Thermal interface materials can be used to provide thermal connections between the heat sources and heat spreaders. Managing charging and discharging of battery systems is often done via electronic battery management systems. Thermal management is often done via heat transfer materials and combinations of both active and passive cooling with air or heat transfer liquid interfaces.

Various composites useful for altering magnetic fields have been disclosed in the art. Such composites are described in, for example, U.S. Pat. Nos. 5,827,445; 5,828,940 and 9,105,382 B2, and U.S. Pat. Publ. Nos. 2005/0012652 A1 and 2006/0099454 A1. Additionally, various methods for forming porous polymer materials have been disclosed in the art. Such composites are described in, for example, U.S. Pat. Nos. 5,196,262 and 6,524,742 B1.

Porous films and membranes foams are generally made via a phase separation process, and therefore typically have relatively small, uniform, pore sizes, and different pore morphologies as compared to foams. The pores on porous films are typically open such that gas, liquid, or vapor can pass from one major surface though the open pores to the other opposed, major surface. Porous films and membranes foams can be made via several phase separation processes, but are typically made via solvent induced phase separation or thermally induced phase separation.

### SUMMARY

In addition, the microchips and semiconductors in mobile communication devices are packed densely with increasing power output of its individual components. While the number of features of the devices increase, the space available to the microelectronic components decreases from one generation of mobile devices to the next. This requires closely packed circuit boards, transistors, cables, antennas, and batteries within a small space. As a result, two major problems occur during normal operation that require novel solutions.

First, all components (integrated circuits, active and passive components, optical disk drives, batteries, sensors, and motors) generate heat during use. To prolong the long term, as well as continuous, use of the devices, the heat must be dissipated. Finned metal blocks and heat spreaders containing heat pipes are commonly used as heat sinks to dissipate the heat generated by devices during use. Thermal interface materials (TIMs) are placed between the heat generating component and the heat sink to improve the thermal coupling between the two components. Different classes of TIMs exists, including gel masses, liquid to solid phase change compounds, greases, and pads that are mechanically clamped between, for example, a printed circuit board (PCB) and heat sink.

Second, electronic devices must be engineered to ensure compatibility with other, nearby electronic devices emitting electromagnetic radiation. For example, electromagnetic interference (EMI) is a challenging problem caused by electrical disturbances from electronic components, generating undesirable responses to another equipment. This problem is evident particularly for high frequency devices used in mobile communication equipment, causing electromagnetic coupling, line-line coupling increased by the electromagnetic coupling, and noise radiation. The electromagnetic interference, occurring between different microelectronic electronic components within mobile communication devices, has become a major cause that not only reduces the capacity of the device but can also cause a malfunction of device.

Hence, the electronic industry and governmental agencies have increased efforts to control the interference by using EMI shielding and buffering material (low dielectric material). Wireless power charging is another recent addition to the functionalities of hand-held electronic devices and the need for higher wireless power charging (WPC) capabilities is inevitable. A Flux Field Directional Material (FFDM) channels the magnetic flux density first through itself and then through the receiver coil of the WPC device, thereby preventing the flux from reaching nearby metallic components such as the case of the battery. The FFDM needs to concentrate and re-direct increasing amounts of flux as the power transfer rate increases.

Due to the multitude of electronic device designs, a further need is to have FFDMs that are easily configured to fit in the desired space within the device. In this regard, flexible materials are desirable. However, the most commonly used current FDDM materials, ferrite sheets, tend to be stiff and inflexible.

Additionally, amorphous or nano-crystalline ribbons (nano-ribbons) have the capability to redirect high magnetic flux densities, but are more expensive to incorporate in consumer electronic devices. They are also limited to lower frequency applications due to their relatively high electrical conductivity and the resulting induction of lossy eddy currents. Ferrite sheets are limited to relatively low saturation magnetic flux density and are very difficult to shape, convert, or handle in manufacturing without breakage. Therefore, it would be preferable to use traditional composite materials for wireless power transfer. However, due to the processing limitations, the maximum loading level of required magnetic flake in current composite materials is only about 50 volume percent, limiting their utility in high power transfer applications.

Also, the current processes employed to produce composite materials generally result in a higher cost material, as compared to ferrites, for example. Despite the cost disadvantage, composite materials have been employed for some FDDM applications at low power transfer rate (about 5 W). However, these materials have limited capability to confine and redirect the higher flux densities needed for higher power transfer rates (15 W and above) in next generation devices. Additionally, as the WPC protocols involve higher frequencies, in some cases exceeding 1 MHz, FFDMs will have to meet more stringent material requirements (e.g., lower resistivity) that current composite materials do not achieve. Overall, there is a need for improved FDDM materials that are capable of at least one of: improved forming characteristics, e.g., improved flexibility, increased power transfer levels and lower cost.

Additional options to deliver or otherwise provide magnetic materials, in combination with thermally-conductive materials, more particularly in particulate form (i.e., as particles), are desired. Porous films generally have the flexibility and can provide intimate contact or cushion between hard plastics or metal. Trapped air, however, is naturally considered an insulator against heat conduction and porous materials featuring trapped air are typically not suitable for heat dissipation. Alternative materials and approaches for dissipating or conducting heat are desired.

The present disclosure describes multifunctional (co)polymer matrix films and processes for making films that provide solutions for both thermal management and electromagnetic radiation control (e.g., FFDM or EMI shielding).

Thus, in one aspect, the present disclosure describes a (co)polymer matrix composite including a porous (co)polymeric network structure, a plurality of thermally-conductive particles, and a plurality of magnetic particles distributed within the (co)polymeric network structure, wherein the thermally-conductive particles and the magnetic particles are present in a range from 15 to 99 (in some embodiments, in a range from 25 to 98, 50 to 98, 75 to 98, or even 93 to 97) weight percent, based on the total weight of the (co)polymer matrix composite (excluding any solvent).

In another aspect, the present disclosure describes a method of making a (co)polymer matrix composite including combining a thermoplastic (co)polymer, a solvent for the thermoplastic (co)polymer, a plurality of thermally-conductive particles, and a plurality of magnetic particles to form a suspension of magnetic particles in a miscible thermoplastic (co)polymer-solvent solution, inducing phase separation of the thermoplastic (co)polymer from the solvent; and removing at least a portion of the solvent to provide the (co)polymer matrix composite. In some exemplary embodiments, inducing phase separation includes at least one of thermally induced phase separation or solvent induced phase separation.

The (co)polymer matrix composites disclosed herein may be useful for thermal management and electromagnetic radiation control applications. (Co)polymer matrix composites described herein are useful, for example, as heat dissipating or heat-shielding films or fillers, fire stop devices, FFDM, EMI shielding, or a combination thereof.

### BRIEF DESCRIPTION OF THE DRAWINGS

The disclosure may be more completely understood by consideration of the following detailed description of various embodiments of the disclosure in connection with the accompanying figures,

in which:

FIG. 1 is a schematic of an exemplary (co)polymer matrix composite described herein.

FIG. 2 is a schematic of another exemplary (co)polymer matrix composite described herein.

FIG. 3 is a schematic of another exemplary (co)polymer matrix composite described herein.

FIGS. 4 and 5 show scanning electron microscope (SEM) micrographs of cross-sections of exemplary (co)polymer matrix composites (Examples C1 and C2, respectively) described herein.

In the drawings, like reference numerals indicate like elements. While the above-identified drawing, which may not be drawn to scale, sets forth various embodiments of the present disclosure, other embodiments are also contemplated, as noted in the Detailed Description. In all cases, this disclosure describes the presently disclosed disclosure by way of representation of exemplary embodiments and not by express limitations. It should be understood that numerous other modifications and embodiments can be devised by those skilled in the art, which fall within the scope and spirit of this disclosure.

### DETAILED DESCRIPTION

For the following Glossary of defined terms, these definitions shall be applied for the entire application, unless a different definition is provided in the claims or elsewhere in the specification.

### Glossary

Certain terms are used throughout the description and the claims that, while for the most part are well known, may require some explanation. Therefore, it should understood that:

The term “homogeneous” means exhibiting only a single phase of matter when observed at a macroscopic scale.

The terms “(co)polymer” or “(co)polymers” includes homopolymers and copolymers, as well as homopolymers or copolymers that may be formed in a miscible blend, e.g., by coextrusion or by reaction, including, e.g., transesterification. The term “copolymer” includes random, block and star (e.g., dendritic) copolymers.

The term “(meth)acrylate” with respect to a monomer, oligomer or means a vinyl-functional alkyl ester formed as the reaction product of an alcohol with an acrylic or a methacrylic acid.

The term “magnetic particles” as used herein, broadly means any particulate material that exhibits a magnetic flux, and is intended to include both magnetically hard and magnetically soft particulate materials. Magnetically hard particles possess intrinsic north and south magnetic poles that are generally independent from externally applied fields. On the other hand, magnetically soft particles generally do not possess net permanent north and south poles in the absence of external magnetic fields; however, such poles can be readily induced by an external field. In the case of soft magnetic materials, after the external field is removed, the induced magnet poles vanish. Soft magnetic particles generally exhibit a coercivity from about 0.1 Oe to about 10 Oe (about 8 to about 800 A/m), more preferably about 0.25 to about 5 Oe (about 20 to about 400 A/M); still more preferably about 0.5 to about 2.5 Oe (about 40 to about 200 A/m). Hard magnetic materials typically exhibit a coercivity greater than 10 Oe (about 800 A/m).

The term “miscible” as used herein refers to the ability of substances to mix in all proportions (i.e., to fully dissolve in each other at any concentration), forming a solution, wherein for some solvent-(co)polymer systems heat may be needed for the (co)polymer to be miscible with the solvent. By contrast, substances are immiscible if a significant proportion does not form a solution. For example, butanone is significantly soluble in water, but these two solvents are not miscible because they are not soluble in all proportions.

The term “phase separation,” as used herein, refers to the process in which particles are uniformly dispersed in a homogeneous (co)polymer-solvent solution that is transformed (e.g., by a change in temperature or solvent concentration) into a continuous three-dimensional (co)polymer matrix composite.

The term “thermally-conductive particles,” as used herein, means particles having a thermal conductivity greater than 2 W/(m° K).

The term “adjacent” with reference to a particular layer means joined with or attached to another layer, in a position wherein the two layers are either next to (i.e., adjoined to) and directly contacting each other, or contiguous with each other but not in direct contact (i.e., there are one or more additional layers intervening between the layers).

Terms of orientation such as “atop”, “on”, “over,” “covering”, “uppermost”, “underlying” and the like for the location of various elements in the disclosed coated articles, refer to the relative position of an element with respect to a horizontally-disposed, upwardly-facing substrate. However, unless otherwise indicated, it is not intended that the substrate or articles should have any particular orientation in space during or after manufacture. For purposes of clarity and without intending to be unduly limited thereby, the tape sheets or strips in a group of any two sequentially stacked sheets or strips are referenced as an overlying tape sheet and an underlying tape sheet with the adhesive layer of the overlying tape sheet adhered to the front or first face of the backing of the underlying tape sheet.

The terms “overlay” or “overlaying” describe the position of a layer with respect to a substrate or layer of a multi-layer article of the present disclosure, we refer to the layer as being atop the substrate or other element, but not necessarily contiguous to either the substrate or the other element.

The term “separated by” to describe the position of a layer with respect to other layers, refers to the layer as being positioned between two other layers but not necessarily contiguous to or adjacent to either layer.

The terms “about” or “approximately” with reference to a numerical value or a shape means +/−five percent of the numerical value or property or characteristic, but expressly includes the exact numerical value. For example, a viscosity of “about” 1 Pa-sec refers to a viscosity from 0.95 to 1.05 Pa-sec, but also expressly includes a viscosity of exactly 1 Pa-sec. Similarly, a perimeter that is “substantially square” is intended to describe a geometric shape having four lateral edges in which each lateral edge has a length which is from 95% to 105% of the length of any other lateral edge, but which also includes a geometric shape in which each lateral edge has exactly the same length.

The term “substantially” with reference to a property or characteristic means that the property or characteristic is exhibited to a greater extent than the opposite of that property or characteristic is exhibited. For example, a substrate that is “substantially” transparent refers to a substrate that transmits more radiation (e.g., visible light) than it fails to transmit (e.g., absorbs and reflects). Thus, a substrate that transmits more than 50% of the visible light incident upon its surface is substantially transparent, but a substrate that transmits 50% or less of the visible light incident upon its surface is not substantially transparent.

As used in this specification and the appended embodiments, the singular forms “a”, “an”, and “the” include plural referents unless the content clearly dictates otherwise. Thus, for example, reference to fine fibers containing “a compound” includes a mixture of two or more compounds. As used in this specification and the appended embodiments, the term “or” is generally employed in its sense including “and/or” unless the content clearly dictates otherwise.

As used in this specification, the recitation of numerical ranges by endpoints includes all numbers subsumed within that range (e.g.,1 to 5 includes 1, 1.5, 2, 2.75, 3, 3.8, 4, and 5).

Unless otherwise noted, all parts, percentages, ratios, etc. used in the specification are expressed based on the weight of the ingredients. Weight percent, percent by weight, % by weight, wt. % and the like are synonyms that refer to the amount of a substance in a composition expressed as the weight of that substance divided by the weight of the composition and multiplied by 100.

Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

Various exemplary embodiments of the disclosure will now be described with particular reference to the Drawings. Exemplary embodiments of the present disclosure may take on various modifications and alterations without departing from the spirit and scope of the disclosure. Accordingly, it is to be understood that the embodiments of the present disclosure are not to be limited to the following described exemplary embodiments, but are to be controlled by the limitations set forth in the claims and any equivalents thereof.

### (Co)Polymer Matrix Composites

In one aspect, the present disclosure describes a (co)polymer matrix composite comprising:

a porous (co)polymeric network structure; and

a plurality of thermally-conductive particles, a plurality of magnetic particles distributed within the (co)polymeric network structure, wherein the magnetic and thermally-conductive particles are present in a range from 15 to 99 (in some embodiments, in a range from 25 to 98, 50 to 98, 75 to 98, or even 93 to 97) weight percent, based on the total weight of magnetic particles and the (co)polymer (excluding any solvent).

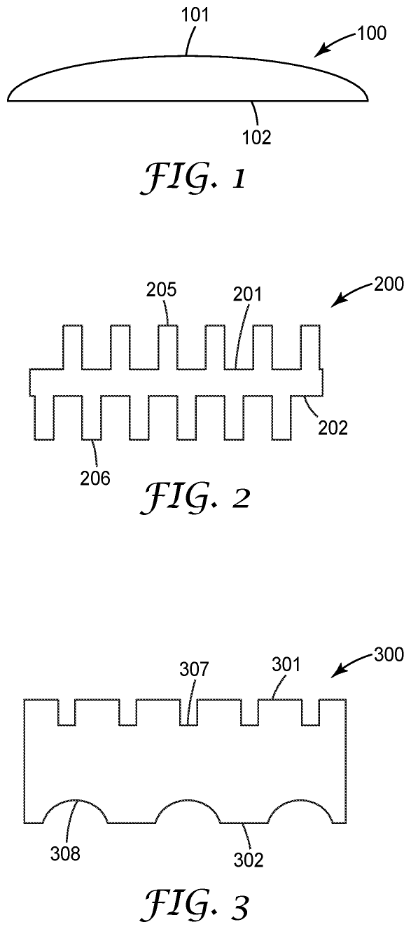

In some embodiments, the (co)polymeric matrix composites have first and second planar, opposed major surfaces. In some embodiments, (co)polymer matrix composites described herein, have first and second opposed major surfaces, wherein the first major surface is nonplanar (e.g., curved). Referring to FIG. 1, exemplary (co)polymer matrix composite described herein 100 has first and second opposed major surfaces 101, 102. First major surface 101 is nonplanar.

Planar and nonplanar major surfaces can be provided, for example, by coating or extruding the slurry onto a patterned substrate (e.g., a liner, a belt, a mold, or a tool). Alternatively, for example, a die with a shaped slot can be used to form nonplanar surfaces during the coating or extrusion process. Alternatively, for example, the structure can be formed after the phase separation has occurred before, and/or after, the solvent is removed by molding or shaping the layer with a patterned tool.

In some embodiments, (co)polymer matrix composites described herein, have first protrusions extending outwardly from the first major surface, and in some embodiments, second protrusions extending outwardly from the second major surface. In some embodiments, the first protrusions are integral with the first major surface, and in some embodiments, the second protrusions are integral with the second major surface. Exemplary protrusions include at least one of a post, a rail, a hook, a pyramid, a continuous rail, a continuous multi-directional rail, a hemisphere, a cylinder, or a multi-lobed cylinder. In some embodiments, the protrusions have a cross-section in at least one of a circle, a square, a rectangle, a triangle, a pentagon, other polygons, a sinusoidal, a herringbone, or a multi-lobe.

Referring to FIG. 2, exemplary (co)polymer matrix composite described herein 200 has first protrusions 205 extending outwardly from first major surface 201 and optional second protrusions 206 extending outwardly from second major surface 202.

Protrusions can be provided, for example, by coating or extruding between patterned substrate (e.g., a liner, a belt, a mold, or a tool). Alternatively, a die with a shaped slot can be used to form protrusions during the coating or extrusion process. Alternatively, for example, the structure can be formed after the phase separation has occurred before, and/or after, the solvent is removed by molding or shaping the film between patterned tools.

In some embodiments, (co)polymer matrix composite described herein, have first depressions extending into the first major surface, and in some embodiments, second depressions extending into the second major surface. Exemplary depressions include at least one of a groove, a slot, an inverted pyramid, a hole (including a thru or blind hole), or a dimple. Referring to FIG. 3, exemplary (co)polymer matrix composite described herein 300 has first depressions 307 extending into first major surface 301 and optional second depressions 308 extending into second major surface 302.

Depressions can be provided, for example, by coating or extruding between a patterned substrate (e.g., a liner, a belt, a mold, or a tool). Alternatively, for example, a die with a shaped slot can be used to form depressions during the coating or extrusion process. Alternatively, for example, the structure can be formed after the phase separation has occurred, before and/or after, the solvent is removed by molding or shaping the film between patterned tools.

In some exemplary embodiments, (co)polymer matrix composites described herein further comprise a reinforcement or support structure (e.g., attached to the (co)polymer matrix composite, partial therein, and/or therein). Exemplary reinforcements or support structures include fibers, strands, nonwovens, woven materials, fabrics, mesh, and films.

Reinforcement/support structures such as nonwovens, wovens, mesh, fibers, etc. can be imbibed with, laminated or adhered to thermally conductive (co)polymer matrix composites to help improve mechanical durability. In some embodiments it can be advantageous for these supports to also be thermally conductive. Thus, metal foils and meshes are particularly, useful as are carbon fibers, glass fibers, and or flame-resistant (co)polymeric fibers (e.g., oriented poly(acrylo)nitrile (OPAN) fibers or poly(phenylene)sulfide (PPS) fibers.

The reinforcement, for example, can be laminated to the (co)polymer matrix composite thermally, adhesively, or ultrasonically. The reinforcement, for example, can be imbedded within the (co)polymer matrix composite during the coating or extrusion process. The reinforcement, for example, can be between the major surfaces of the composite, on one major surface, or on both major surfaces. More than one type of reinforcement can be used.

The (co)polymeric network structure may be described as a porous (co)polymeric network or a porous phase-separated (co)polymeric network. Generally, the porous (co)polymeric network (as-made) includes an interconnected porous (co)polymeric network structure comprising a plurality of interconnected morphologies (e.g., at least one of fibrils, nodules, nodes, open cells, closed cells, leafy laces, strands, nodes, spheres, or honeycombs). The interconnected (co)polymeric structures may adhere directly to the surface of the particles and act as a binder for the particles. In this regard, the space between adjacent particles (e.g., particles or agglomerate particles) may include porous (co)polymeric network structures, as opposed to a solid matrix material, thereby providing desired porosity.

In some embodiments, the (co)polymeric network structure may include a 3-dimensional reticular structure that includes an interconnected network of (co)polymeric fibrils. In some embodiments, individual fibrils have an average width in a range from 10 nm to 100 nm (in some embodiments, in a range from 100 nm to 500 nm, or even 500 nm to 5 micrometers).

In some embodiments, the thermally-conductive particles, magnetic particles and optional magnetic particles are dispersed within the (co)polymeric network structure, such that an external surface of the individual units of the particles (e.g., individual particles or individual agglomerate particles) is mostly uncontacted, or uncoated, by the (co)polymeric network structure. In this regard, in some embodiments, the average percent areal coverage of the (co)polymeric network structure on the external surface of the individual particles (i.e., the percent of the external surface area that is in direct contact with the (co)polymeric network structure) is not greater than 50 (in some embodiments, not greater than 40, 30, 25, 20, 10, 5, or even not greater than 1) percent, based on the total surface area of the external surfaces of the individual particles. Although not wanting to be bound by theory, it is believed that the large, uncontacted surface area coating on the particles enables increased particle-to-particle contact upon compression and therefore increases thermal conductivity.

In some embodiments, the (co)polymeric network structure does not penetrate internal porosity or internal surface area of the individual particles (e.g., individual particles or individual agglomerate particles) are mostly uncontacted, or uncoated, by the (co)polymeric network structure.

Although not wishing to be bound by theory, it is thought that the formation of the thermoplastic polymer, network structure gives the (co)polymer matrix composites of the present disclosure improved flexibility compared to a conventional composite material, i.e., composite without the thermoplastic polymer network structure, while enabling higher mass/volume loading of soft, ferromagnetic particulate material. Surprisingly, this unique construction enables better handling characteristics in end use applications, likely due to the more flexible nature of the thermoplastic polymer, network structure, while having improved performance as a magnetic FFDM, likely due to the ability to obtain higher loading of the soft, ferromagnetic particulate material within the (co)polymer matrix composite.

In order to increase the magnetic FFDM characteristics of the (co)polymer matrix composites of the present disclosure, it is desirable to increase the amount of the soft, ferromagnetic particulate material in the (co)polymer matrix composite. In some embodiments, the weight fraction of soft, ferromagnetic particulate material may be between 0.80 and 0.98, between 0.85 and 0.97 or even between 0.90 and 0.96, based on the total weight of the (co)polymer matrix composite. In some embodiments, the volume fraction of soft, ferromagnetic particulate material may be between 0.10 and 0.80, between 0.20 and 0.80, between 0.30 and 0.80, between 0.10 and 0.75, between 0.20 and 0.75, between 0.30 and 0.75, between 0.10 and 0.70, between 0.20 and 0.70 or even between 0.30 and 0.70, based on the total volume of the (co)polymer matrix composite.

Additionally, in order to increase the magnetic FFDM characteristics of the (co)polymer matrix composites of the present disclosure, it is desirable to have a (co)polymer matrix composite having a high density. Increasing the density of the (co)polymer matrix composite can be achieved in a variety of ways, including, but not limited to, using a higher density soft, ferromagnetic particulate material; using a higher weight fraction of soft, ferromagnetic particulate material in the (co)polymer matrix composite; and/or densifying a portion of the thermoplastic polymer network structure of the (co)polymer matrix composite.

The unique structure of the (co)polymer matrix composites of the present disclosure offers an alternative means of densifying the (co)polymer matrix composite not available to traditional composites, as the thermoplastic polymer network structure of the (co)polymer matrix composites of the present disclosure may be collapsed by the application of at least one of a compressive or tensile force, thereby densifying the (co)polymer matrix composite. Although high densities can be achieved, the densification process may be conducted at a temperature that produces plastic deformation of the thermoplastic polymer of the thermoplastic polymer, network structure, which allows a small portion of the thermoplastic polymer, network structure to remain.

This process yields a high-density material with enhanced FFDM characteristics (compared to the non-collapsed (co)polymer matrix composite), while still maintaining the improved handling characteristics associated with the flexibility of the thermoplastic polymer, network structure. Generally, it is not desirable to collapse the thermoplastic polymer, network structure at a temperature that will melt the thermoplastic polymer network structure, as this may result in a loss of the thermoplastic polymer network structure. In some embodiments, the (co)polymer matrix composite is not exposed to a temperature above the glass transition temperature of the thermoplastic polymer.

In some embodiments, the (co)polymer matrix composite is not exposed to a temperature above the melting temperature of the thermoplastic polymer. In some embodiments, when two or more thermoplastic polymer types are used for the thermoplastic polymer, the (co)polymer matrix composite is not exposed to a temperature above the highest glass transition temperature of the thermoplastic polymer. In some embodiments, when two or more thermoplastic polymer types are used for the thermoplastic polymer, the (co)polymer matrix composite is not exposed to a temperature above the highest melting temperature of the thermoplastic polymer.

In some embodiments, thermoplastic polymer, network structure may be plastically deformed. In some embodiments, thermoplastic polymer, network structure may be plastically deformed by at least one of a compressive force and a tensile force. In some embodiments, thermoplastic polymer, network structure may be plastically deformed by only a compressive force. In some embodiments, thermoplastic polymer, network structure may be plastically deformed by only a tensile force. T

The flexibility of the (co)polymer matrix composite can be determined through a variety of techniques, such as, a flexural modulus test or by examining the ability of a sheet of the (co)polymer matrix composite to bend around a cylindrical object having a defined radius, i.e., a defined radius of curvature.

In some embodiments, the (co)polymer matrix composite is capable of bending to form a radius of curvature of 10 mm, 5 mm or even 3 mm, when the (co)polymer matrix composite is in the form of a sheet having a thickness between 20 micrometers to 300 micrometers. In some embodiments, the (co)polymer matrix composite is capable of bending to form a radius of curvature of 10 mm, 5 mm or even 3 mm, when the (co)polymer matrix composite is in the form of a sheet having a thickness of 150 micrometers.

In some embodiments where the network structure is plastically-deformed by at least a compressive force, vibratory energy may be imparted during the application of the compressive force. In some of these embodiments, the (co)polymer matrix composite sheet is in the form of a strip of indefinite (any) length, and the applying of a compressive force step is performed as the strip passes through a nip. A tensile loading may be applied during passage through such a nip.

For example, the nip may be formed between two rollers, at least one of which applies the vibratory energy; between a roller and a bar, at least one of which applies the vibratory energy; or between two bars, at least one of which applies the vibratory energy. The applying of the compressive force and the vibratory energy may be accomplished in a continuous roll-to-roll fashion, or in a step-and-repeat fashion.

In certain embodiments, the applying a compressive force step is performed on a discrete sheet having a finite length positioned between, e.g., a plate and a platen, at least one of which applies the vibratory energy.

In some embodiments, the vibratory energy is in the ultrasonic range, e.g., 20 kHz, but other ranges are considered to be suitable. When vibratory energy is employed during the application of compressive force, particle fractions greater than 52 volume % can be achieved, while still obtaining excellent magnetic properties. (co)polymer matrix composite sheets with magnetic coercivity no greater than 240 A/m, or even 200 A/m, can be obtained.

When the (co)polymer matrix composite is in the form of a sheet having a first major surface and when the soft, ferromagnetic magnetic particulate has at least one aspect ratio, based on length dimension/thickness dimension, that is greater than one (an anisotropic particulate with respect to shape, e.g., flake), the deformation, e.g., plastic deformation, of the thermoplastic polymer, network structure may orient the length dimension of soft, ferromagnetic magnetic particulate relative to the first major surface of the (co)polymer matrix composite.

Aligning or orienting the length dimension of an anisotropic soft, ferromagnetic magnetic particulate relative to the first major surface of the (co)polymer matrix composite sheet may improve the FFDM characteristics of the (co)polymer matrix composite. In some embodiments, the (co)polymer matrix composite is in the form of a sheet having a first major surface and the soft, ferromagnetic particulate material is a soft, ferromagnetic particulate flake material, each flake having a first major surface and a thickness normal to the first major surface of the flake, wherein a majority of the first major surfaces of the flakes are oriented to be within at least 25 degrees of the adjacent first major surface of the (co)polymer matrix composite sheet.

By “majority” it is meant that at least 50 percent of the flakes of the first major surfaces of the flakes are oriented to be within at least 25 degrees of the adjacent first major surface of the (co)polymer matrix composite sheet. In some embodiments, at least 30 percent, at least 50 percent, at least 70 percent, at least 80 percent, at least 90 percent, at least 95 percent, at least 98 percent or even 100 percent of the first major surfaces of the flakes are oriented to be within at least 25 degrees, at least 20 degrees, at least 15 degrees or even at least even 10 degrees of the adjacent first major surface of the (co)polymer matrix composite sheet.

In some embodiments, the (co)polymer matrix composite is in the form of a sheet having a first major surface and a thickness of between 20 micrometers and 5000 micrometers and, the soft, ferromagnetic particulate material is a soft, ferromagnetic particulate flake material, each flake having a first major surface and a thickness normal to the first major surface of the flake, wherein a majority of the first major surfaces of the flakes are oriented to be within at least 25 degrees of the adjacent first major surface of the (co)polymer matrix composite sheet.

The density of the (co)polymer matrix composite may vary, depending on the density and amount of soft, ferromagnetic particulate material used, the density of the thermoplastic polymer and the porosity of the thermoplastic polymer network structure. Generally, the higher the density, the greater the magnetic properties, e.g., FFDM characteristics, of the (co)polymer matrix composite.

In some embodiments, the density of the (co)polymer matrix composite is between 1.5 g/cm³ and 6 g/cm³, between 1.5 g/cm³ and 5.5 g/cm³, between 1.5 g/cm³ between 3.0 g/cm³, between 1.5 g/cm³ and 2.5 g/cm³, between 3.0 g/cm³ and 6.0 g/cm³, between 3.0 g/cm³ and 5.5 g/cm³, between 3.0 g/cm³ and 5.0 g/cm³, between 3.5 g/cm³ and 6.0 g/cm³, between 3.5 g/cm³ and 5.5 g/cm³ or even between 3.5 g/cm³ and 5.0 g/cm³.

In some embodiments, (co)polymer matrix composites described herein have a porosity of at least 5 (in some embodiments, in a range from 10 to 80, 20 to 70, or even 30 to 60) percent.

In some embodiments, (co)polymer matrix composites described herein have a porosity less than 80 (in some embodiments, in a range from 0 to 80, 0 to 70, 0 to 60, 10 to 80, 10 to 70, 10 to 60, 10 to 50, 10 to 40, 10 to 30, or even 5 to 20) percent.

In some embodiments, (co)polymer matrix composites described herein, are in the form of a layer having a thickness in a range from 50 to 11000 micrometers, wherein the thickness excludes the height of any protrusions extending from the base of the layer.

The thickness of the (co)polymer matrix composite, e.g., the thickness of a (co)polymer matrix composite sheet, is not particularly limited. However, for many applications, e.g., mobile/handheld electronic devices, it is desirable for this thickness of the (co)polymer matrix composite, e.g., the thickness of a (co)polymer matrix composite sheet, to be below 5000 micrometers, below 3000 micrometers or even below 1000 micrometers and above 20 micrometers, 40 micrometers or even above 60 micrometers.

In some embodiments, the thickness of the (co)polymer matrix composite, e.g., the thickness of a (co)polymer matrix composite sheet, is between 20 micrometers and 5000 micrometers, between 20 micrometers and 3000 micrometers, between 20 micrometers and 1000 micrometers, between 20 micrometers and 500 micrometers, between 20 micrometers and 300 micrometers, between 40 micrometers and 5000 micrometers, between 40 micrometers and 3000 micrometers, between 40 micrometers and 1000 micrometers, between 40 micrometers and 500 micrometers, between 40 micrometers and 300 micrometers, between 60 micrometers and 5000 micrometers, between 60 micrometers and 3000 micrometers, between 60 micrometers and 1000 micrometers, between 60 micrometers and 500 micrometers or even between 60 micrometers and 300 micrometers.

In some exemplary embodiments, the thermally-conductive particles and the magnetic particles are present in a single layer comprised of the (co)polymer matrix composite. In certain such embodiments, the thermally-conductive particles and the magnetic particles may be substantially homogenously distributed within the layer.

In other exemplary embodiments, the thermally-conductive particles are present in a first layer comprised of the (co)polymer matrix composite, and the magnetic particles are present in a second layer adjacent to the first layer. Optionally, the second layer adjoins the first layer.

In additional exemplary embodiments, the thermally-conductive particles are present in a first layer comprised of the (co)polymer matrix composite having opposed first and second major surfaces, and the magnetic particles are present in a second layer overlaying and adjacent to the first major surface of the first layer and a third layer overlaying and adjacent to the second major surface of the first layer. Optionally, the second layer adjoins the first major surface, and the third layer adjoins the second major surface.

In further exemplary embodiments, the magnetic particles are present in a first layer comprised of the (co)polymer matrix composite having opposed first and second major surfaces, and the thermally-conductive particles are present in a second layer overlaying and adjacent to the first major surface of the first layer and in a third layer overlaying and adjacent to the second major surface of the first layer. Optionally, the second layer adjoins the first major surface, and the third layer adjoins the second major surface.

It will be understood that various ordering and arrangements of multiple layers comprising one or both of the thermally-conductive particles and the magnetic particles are within the scope of the present disclosure.

Aspects of the (co)polymer matrix composite that affect the magnetic properties of the (co)polymer matrix composite, include, but are not limited to, the type of and amount of soft, ferromagnetic particulate material used in the (co)polymer matrix composite, the particulate shape, e.g., flake, and the orientation of the particulate, if it is anisotropic in shape. Orientation of the first major surfaces of the flakes of the soft, ferromagnetic particulate flake material, relative to the first major surface of the (co)polymer matrix composite sheet, may lead to enhanced magnetic properties of the (co)polymer matrix composite sheet.

By “orientation” with respect to magnetic properties, it is meant that the first major surface of a flake is aligned with the first major surface of the composite sheet. Perfect alignment, i.e., perfect orientation, would be if the first major surface of the flake was parallel to the first major surface of the (co)polymer matrix composite sheet, i.e., the angle between the first major surface of a flake and the first major surface of the (co)polymer matrix composite would be zero degrees.

In some embodiments, the (co)polymer matrix composite has a magnetic saturation induction between 600 mT to 1000 mT, between 600 mT and 900 mT, between 700 and 100 mT or even between 700 and 900 mT.

In electromagnetism, the ability of a material to support the formation of a magnetic field within itself is called the permeability, and represents the degree to which a material can be magnetized in response to an applied magnetic field. The relative permeability is the ratio of the permeability of a material, μ, to the permeability of free space, i.e., vacuum, μₒ. The permeability of free space, μₒ, may be defined as 1.257×10⁻⁶ H/m.

In some embodiments, the magnitude of the relative permeability, μ/μₒ, of the (co)polymer matrix composites of the present disclosure at a frequency of 1 MHz may be greater than 70, greater than 150 or even greater than 500. In some embodiments, the magnitude of the relative permeability at a frequency between 50 MHz to 1000 MHz is greater than 70, greater than 150 or even greater than 500. In some embodiments, the magnitude of the relative permeability at a frequency between 50 MHz to 300 MHz is greater than 70, greater than 150 or even greater than 500.

The unique method of making the (co)polymer matrix composite, which includes an induced phase separation of a thermoplastic polymer-solvent mixture containing the soft, ferromagnetic particulate material, allows for very high loading of the soft, ferromagnetic particulate material (up to about 80 percent by volume) and low polymer content (down to about 4 percent by weight) within the (co)polymer matrix composite, due to the thermoplastic polymer, network structure formed during the fabrication process. As a consequence, a high saturation magnetic flux density, e.g., 0.67 T, can be achieved using approximately 100 micrometer thick films of the (co)polymer matrix composite, which will enable these (co)polymer matrix composites to improve the high power, wireless charging capabilities of electronic devices. The unique structure of the composite, which includes a thermoplastic polymer, network structure, also enables improved flexibility and forming characteristics of the (co)polymer matrix composite of the present disclosure.

The thermoplastic polymer, network structure is, inherently, porous and may have a continuous, porous network structure. In some embodiments, at least a portion of the thermoplastic polymer, network structure is a continuous thermoplastic polymer, network structure. In some embodiments, at least 10 percent, at least 30 percent, at least 50 percent, at least 70 percent, at least 90 percent, at least 95 percent or even the entire thermoplastic polymer, network structure, by volume, is a continuous thermoplastic polymer, network structure.

It should be noted that the portion of the volume of the (co)polymer matrix composite associated with the soft, ferromagnetic particulate material distributed within the thermoplastic polymer, network structure is not considered part of the thermoplastic polymer, network structure. In some embodiments, the soft, ferromagnetic particulate material is uniformly distributed within the thermoplastic polymer, network structure. In some embodiments, when the soft, ferromagnetic particulate material is an anisotropic, soft, ferromagnetic particulate material, the anisotropic, soft, ferromagnetic particulate material may be randomly distributed within the thermoplastic polymer, network structure. By “random”, it is meant without orientation of the particulate material with respect to its anisotropy. In some embodiments, when the soft, ferromagnetic particulate material is an anisotropic, soft, ferromagnetic particulate material, the anisotropic, soft, ferromagnetic particulate material may be uniformly and randomly distributed within the thermoplastic polymer, network structure.

In some embodiments, the anisotropic, soft, ferromagnetic particulate material may be distributed such that the anisotropic, soft, ferromagnetic particulate material is oriented within the thermoplastic polymer, network structure. In other embodiments, the anisotropic, soft, ferromagnetic particulate material may be uniformly distributed such that the anisotropic, soft, ferromagnetic particulate material is oriented within the thermoplastic polymer, network structure.

### (Co)Polymers

In some embodiments, the (co)polymeric network structure may comprise, consist essentially of, or consist of at least one thermoplastic (co)polymer. Exemplary thermoplastic (co)polymers include polyurethane, polyester (e.g., polyethylene terephthalate, polybutylene terephthalate, and polylactic acid), polyamide (e.g., nylon 6, nylon 6,6, nylon 12 and polypeptide), polyether (e.g., polyethylene oxide and polypropylene oxide), polycarbonate (e.g., bisphenol-A-polycarbonate), polyimide, polysulphone, polyethersulphone, polyphenylene oxide, polyacrylate (e.g., thermoplastic (co)polymers formed from the addition (co)polymerization of monomer(s) containing an acrylate functional group), poly(meth)acrylate (e.g., thermoplastic (co)polymers formed from the addition (co)polymerization of monomer(s) containing a (meth)acrylate functional group), polyolefin (e.g., polyethylene and polypropylene), styrene and styrene-based random and block copolymer, chlorinated (co)polymer (e.g., polyvinyl chloride), fluorinated (co)polymer (e.g., polyvinylidene fluoride; (co)polymers of tetrafluoroethylene, hexafluoropropylene and vinylidene fluoride; (co)polymers of ethylene, tetrafluoroethylene; hexafluoropropylene; and polytetrafluoroethylene), (co)polymers of ethylene and chlorotrifluoroethylene, and combinations thereof.

In some embodiments, thermoplastic (co)polymers include homopolymers or copolymers (e.g., block copolymers or random copolymers).

In some embodiments, the thermoplastic (co)polymer is a single thermoplastic (co)polymer (i.e., it is not a mixture of at least two thermoplastic (co)polymer types). In some embodiments, the thermoplastic (co)polymers consist essentially of, or consist of polyethylene (e.g., ultra-high molecular weight polyethylene).

In some embodiments, the porous (co)polymeric network structure comprises at least one of polyacrylonitrile, polyurethane, polyester, polyamide, polyether, polycarbonate, polyimide, polysulfone, polyphenylene oxide, polyacrylate, poly(meth)acrylate, polyolefin, styrene or styrene-based random and block (co)polymer, chlorinated (co)polymer, fluorinated (co)polymer, or (co)polymers of ethylene and chlorotrifluoroethylene.

In some embodiments, thermoplastic (co)polymers include a mixture of at least two thermoplastic (co)polymer types (e.g., a mixture of polyethylene and polypropylene or a mixture of polyethylene and polyacrylate). In some embodiments, the (co)polymer may be at least one of polyethylene (e.g., ultra-high molecular weight polyethylene), polypropylene (e.g., ultra-high molecular weight polypropylene), polylactic acid, poly(ethylene-co-chlorotrifluoroethylene) and polyvinylidene fluoride.

In further exemplary embodiments, the porous (co)polymeric network structure advantageously comprises a crosslinked polysiloxane (co)polymer (e.g., a crosslinked poly(meth)acrylosiloxane copolymer). In certain such exemplary embodiments, the crosslinked polysiloxane (co)polymer may be advantageously used to provide a (co)polymeric network structure that exhibits a low activation temperature (e.g., activating at a temperature of less than 150° C., less than 140° C., less than 130° C., less than 120° C., less than 110° C., or even less than 10° C.) for the incorporated endothermic particles.

In some embodiments, the porous (co)polymeric network structure comprises a (co)polymer having a number average molecular weight in a range from 5×10⁴ to 1×10⁷ (in some embodiments, in a range from 1×10⁶ to 8×10⁶, 2×10⁶ to 6×10⁶, or even 3×10⁶ to 5×10⁶) g/mol. For purposes of the present disclosure, the number average molecular weight can be measured by known techniques in the art (e.g., gel permeation chromatography (GPC)). GPC may be conducted in a suitable solvent for the thermoplastic (co)polymer, along with the use of narrow molecular weight distribution (co)polymer standards (e.g., narrow molecular weight distribution polystyrene standards).

Thermoplastic (co)polymers are generally characterized as being partially crystalline, exhibiting a melting point. In some embodiments, the thermoplastic (co)polymer may have a melting point in a range from 120 to 350 (in some embodiments, in a range from 120 to 300, 120 to 250, or even 120 to 200) ° C. The melting point of the thermoplastic (co)polymer can be measured by known techniques in the art (e.g., the on-set temperature measured in a differential scanning calorimetry (DSC) test, conducted with a 5 to 10 mg sample, at a heating scan rate of 10° C./min., while the sample is under a nitrogen atmosphere).

In some embodiments, the (co)polymeric network structure is a continuous network structure (i.e., the (co)polymer phase comprises a structure that is open cell with continuous voids or pores forming interconnections between the voids, extending throughout the structure). In some embodiments, at least 2 (in some embodiments, at least 5, 10, 20, 30, 40, 50, 60, 70, 80, 90, 95, or even, 100) percent of the (co)polymer network structure, by volume, may be a continuous (co)polymer network structure. It should be noted that for purposes of the present disclosure, the portion of the volume of the (co)polymer matrix composite made up of the particles is not considered part of the (co)polymeric network structure. In some embodiments, the (co)polymer network extends between two particles forming a network of interconnected particles.

In some embodiments, the thermoplastic (co)polymer used to make the (co)polymer matrix composites described herein are particles having a particle size less than 1000 (in some embodiments, in a range from 1 to 10, 10 to 30, 30 to 100, 100 to 200, 200 to 500, 500 to 1000) micrometers.

### Solvents

The solvent is typically selected such that it is capable of dissolving the (co)polymer and forming a miscible (co)polymer-solvent solution. Heating the solution to an elevated temperature may facilitate the dissolution of the (co)polymer. In some embodiments, combining the (co)polymer and solvent is conducted at at least one temperature in a range from 20° C. to 350° C. The thermally-conductive and/or magnetic particles may be added at any or all of the combining, before the (co)polymer is dissolved, after the (co)polymer is dissolved, or at any time there between.

In some embodiments, the solvent is a blend of at least two individual solvents. In some embodiments, when the (co)polymer is a polyolefin (e.g., at least one of polyethylene or polypropylene), the solvent may be at least one of mineral oil, paraffin oil/wax, camphene, orange oil, vegetable oil, castor oil, or palm kernel oil. In some embodiments, when the (co)polymer is polyvinylidene fluoride, the solvent is at least one of ethylene carbonate, propylene carbonate, or 1,2,3 triacetoxypropane.

In some embodiments, the solvent may be removed, for example, by evaporation, high vapor pressure solvents being particularly suited to this method of removal. If the first solvent, however, has a low vapor pressure, a second solvent, of higher vapor pressure, may be used to extract the first solvent, followed by evaporation of the second solvent. For example, in some embodiments, when mineral oil is used as a first solvent, isopropanol at elevated temperature (e.g., about 60° C.) or a blend of methyl nonafluorobutyl ether (C₄F₉OCH₃), ethylnonafluorobutyl ether (C₄F₉OC₂H₅), and trans-1,2-dichloroethylene (available under the trade designation “NOVEC 72DE” from 3M Company, St. Paul, Minn.) may be used as a second solvent to extract the first solvent, followed by evaporation of the second solvent.

In some embodiments, when at least one of vegetable oil or palm kernel oil is used as the first solvent, isopropanol at elevated temperature (e.g., about 60° C.) may be used as the second solvent. In some embodiments, when ethylene carbonate is used as the first solvent, water may be used as the second solvent.

In some embodiments, small quantities of other additives can be added to the (co)polymer matrix composite to impart additional functionality or act as processing aids. These include viscosity modifiers (e.g., fumed silica, block (co)polymers, and wax), plasticizers, thermal stabilizers (e.g., such as available, for example, under the trade designation “IRGANOX 1010” from BASF, Ludwigshafen, Germany), antimicrobials (e.g., silver and quaternary ammonium), flame retardants, antioxidants, dyes, pigments, and ultraviolet (UV) stabilizers.

### Particles

The thermally-conductive particles and magnetic particles are generally present in a range from 15 to 99 (in some embodiments, in a range from 25 to 98, 50 to 98, 75 to 98, or even 93 to 97) weight percent, based on the total weight of the (co)polymer matrix composite (excluding any optional solvent).

### Thermally-Conductive Particles

Exemplary thermally conductive particles include conductive carbon, metals, semiconductors, and ceramics.

In some embodiments, the thermally conductive particles comprise electrically non-conductive particles (e.g., ceramic particles comprising boron nitride, aluminum trihydrate, silica carbide, and metal oxides (e.g., aluminum oxide, iron oxide), magnesium oxide, zinc oxide, and the like).

In some embodiments, the thermally conductive particles comprise electrically conductive particles (e.g., carbon particles such as carbon black, graphite or graphene; and metal particles comprising at least one metal selected from aluminum, copper, nickel, platinum, silver and gold).

Exemplary thermally conductive particles include metals, semiconductors, and ceramics. Exemplary thermally conductive particles comprise at least one of aluminum, copper, silver, graphite, diamond, SiC, Si₃N₄, MN, BeO, MgO, Al₂O₃, aluminum hydroxide, aluminum oxyhydroxide, hexagonal boron nitride (h-BN), cubic boron nitride (c-BN), ZnO, natural aluminosilicate, or synthetic aluminosilicate.

Exemplary sizes of the thermally conductive particles range from 1-100s of nanometers to 1-100s of micrometers in size. Exemplary shapes of the thermally conductive particles include irregular, platy, acicular, tetrapods, spherical shapes, and as well as agglomerated forms. Agglomerates can range in size, for example, from a few micrometers up to, and including, a few millimeters. The particles can be mixed to have multimodal size distributions which may, for example, allow for optimal packing density.

In some embodiments, the thermally conductive particles comprise a mixture of two or more particle types selected from carbon black, graphite, graphene, aluminum, copper, silver, graphite, diamond, SiC, Si₃N₄, MN, BeO, MgO, Al₂O₃, aluminum hydroxide, aluminum oxyhydroxide, hexagonal boron nitride (h-BN), cubic boron nitride (c-BN), ZnO, natural aluminosilicate, or synthetic aluminosilicate.

In some embodiments, the thermally conductive particles have an average particle size (average length of longest dimension) in a range from 100 nm to 2 mm (in some embodiments, in a range from 200 nm to 1000 nm).

In some embodiments, the thermally conductive particles have bimodal or trimodal distribution. Multimodal distributions of particles can allow for higher packing efficiency, improved particle-to-particle contact and thereby improved thermal conductivity.

### Magnetic Particles

The (co)polymer matrix composites of the present disclosure include both magnetically hard and magnetically soft magnetic particulate material. Magnetically hard materials are generally useful for permanent magnet applications. Suitable magnetically hard materials include metal-based alloys such as: Fe—Cr—Co, Nd—Fe—B, Sm—Co, Sm—Fe—N, Al—Ni—Co, Cu—Ni—Fe, Cu—Ni—Fe—Co, steels with a ferritic or martensitic crystal structures, and ferrites such as: barium ferrite and strontium ferrite.

Magnetically soft materials are generally useful for magnetic isolation, flux-directing applications. Suitable magnetically soft materials include metal-based alloys such as Fe-based amorphous nitrides, Fe-based nanocrystalline nitrides, Fe-based nanocrystalline nitrides, Fe—Al—Si, Fe—Cr, Fe—Si, Fe—Si—B, Fe—Si—Cr, Fe—Co—B, Ni—Fe, Ni—Fe—Mo, Ni—Si, Co—Nb—Zr, boron based amorphous alloys, and soft ferrites such as: iron oxide (magnetite), Ni—Zn, and Mn—Zn alloy.

The term “soft” in describing the ferromagnetic particulate material has its traditional meaning in the art and relates to the ability of a non-magnetic material to become magnetic, when placed within a magnetic field, e.g., a weak magnetic field. The induced magnetism of the soft, ferromagnetic particulate material, will substantially vanish when the magnetic field is removed, i.e., the material exhibits reversible magnetism in an applied magnetic field.

In some embodiments, the coercivity of the soft magnetic particulate material is between 1 A/m to 1000 A/m, between 10 A/m to 1000 A/m or even between 30 A/m to 1000 A/m. In some embodiments, the coercivity of the soft magnetic particulate material is less than or equal to 1000 A/m. Soft ferromagnetic materials may have narrow hysteresis loops, i.e., low values of coercive field, Hc, high magnetic saturation inductions, high permeability and, for high frequency application, desirably have low electrical conductivity to minimize eddy current power losses.

In some embodiments, the soft, ferromagnetic particulate material may include at least one of iron, including, but not limited to, Fe—Cr alloys, Fe—Si alloys (including, but not limited to, Fe—Si—Al, which is commercially available under the trade designation SENDUST from Tianjin Ecotech Trade Co., Ltd., Tianjin, China, and Fe—Si—Cr,), FeCoB, Fe-based amorphous alloys, nanocrystalline Fe-based oxides, and nanocrystalline Fe-based nitrides; nickel based alloys, including, but not limited to, Ni—Fe alloys and Ni—Si alloys; CoNbZr; and boron based amorphous alloy.

The shape of the soft, ferromagnetic particulate material is not particularly limited, however, flake shaped particulate may be particularly beneficial. A flake may be considered an irregularly shaped, plate-like structure, having a first and second major surface and a thickness, substantially normal to at least one of the first and second major surfaces. In some embodiments, the soft, ferromagnetic particulate material is a soft, ferromagnetic particulate flake material, each flake having a first major surface and a maximum thickness, T, normal to the first major surface of the flake.

The flakes of the soft, ferromagnetic particulate flake material may be characterized by a median diameter, D50 (which relates to a length dimension, L) and a maximum thickness, T. In some embodiments, the soft, ferromagnetic particulate material may be an anisotropic, soft, ferromagnetic particulate material. The aspect ratio of an anisotropic soft, ferromagnetic particulate may be defined as the median diameter, D50, as determined by particle size analysis for example, divided by the maximum thickness of the anisotropic particulate, as determined from image analysis for example.

For a particular set of soft, ferromagnetic particulate material, the value of the maximum thickness may be taken as the median value, Tm. The ratio D50/Tm is the median aspect ratio. In some embodiments, the median aspect ratio, D50/Tm, is between 5/1 to 1000/1, between 10/1 to 1000/1, between 20/1 to 1000/1, between 5/1 to 500/1, between 10/1 and to 500/1, between 20/1 to 500/1, between 5/1 to 200/1, between 10/1 to 200/1 or even between 20/1 to 200/1.

In some embodiments, the image length of a flake, Li, as observed and measured in a cross-sectional image of the (co)polymer matrix composite, may be taken as the length of the flake, and the image thickness of a flake, Ti, may be taken as the largest thickness of a flake, as observed and measured in a cross-sectional image of the (co)polymer matrix composite. The image may be an optical micrograph or SEM, for example. For a particular set of soft, ferromagnetic particulate flake material, the values of Li and Ti may be taken as average values, Lia (average image length) and Tia (average image thickness), of a subset of flakes using standard statistical analysis methods. In some embodiments, Lia/Tia is between 5/1 and 1000/1, between 10/1 and 1000/1, between 20/1 and 1000/1, between 5/1 and 500/1, between 10/1 and 500/1, between 20/1 and 500/1, between 5/1 and 200/1, between 10/1 and 200/1 or even between 20/1 and 200/1.

In some embodiments, D50 is between 5 micrometers to 5000 micrometers, between 5 micrometers to 1000 micrometers, between 5 micrometers to 500 micrometers, between 5 micrometers to 200 micrometers, between 10 micrometers to 5000 micrometers, between 10 micrometers to 1000 micrometers, between 10 micrometers to 500 micrometers, between 10 micrometers to 200 micrometers, between 25 micrometers to 5000 micrometers, between 25 micrometers to 1000 micrometers, between 25 micrometers to 500 micrometers or even between 25 micrometers to 200 micrometers.

In some embodiments, the flakes of the soft, ferromagnetic particulate flake material have a median diameter, D50, and the thermoplastic polymer, network structure has an average pore size, P, and D50>2P. In some embodiments, D50 is between 25 micrometers to 5000 micrometers, P is between 50 nanometers to 25 micrometers and D50>2P. In some embodiments, D50 is between 10 micrometers to 5000 micrometers, P is between 50 nanometers to 25 micrometers and D50>2P. In some embodiments, D50 is between 25 micrometers to 5000 micrometers, P is between 50 nanometers to 25 micrometers and D50>4P. In some embodiments, D50 is between 10 micrometers to 5000 micrometers, P is between 50 nanometers to 25 micrometers and D50>4P. In some embodiments, D50 is between 25 micrometers to 5000 micrometers, P is between 50 nanometers to 25 micrometers and D50>6P. In some embodiments, D50 is between 10 micrometers to 5000 micrometers, P is between 50 nanometers to 25 micrometers and D50>6P.

### Methods of Making the (Co)Polymer Matrix Composite

Various methods may be used to make the (co)polymer matrix composites of the present disclosure. In some embodiments, the porous (co)polymeric network structure is produced by an induced phase separation of a miscible thermoplastic (co)polymer-solvent solution. In some embodiments, induced phase separation is at least one of thermally induced phase separation or solvent induced phase separation.

### First Method

In another aspect, the present disclosure describes a first method of making (co)polymer matrix composites described herein, the method comprising:

combining (e.g., mixing or blending) a thermoplastic (co)polymer, a solvent, a plurality of thermally-conductive particles, and a plurality of magnetic particles to provide a slurry;

forming the slurry in to an article (e.g., a layer);

heating the article in an environment to retain at least 90 (in some embodiments, at least 91, 92, 93, 94, 95, 96, 97, 98, 99, or even at least 99.5) percent by weight of the solvent in the article, based on the weight of the solvent in the article, and solubilize at least 50 (in some embodiments, at least 55, 60, 65, 70, 75, 80, 85, 90, 95, 96, 97, 98, 99, or even 100) percent of the thermoplastic (co)polymer, based on the total weight of the thermoplastic (co)polymer; and

inducing phase separation of the thermoplastic (co)polymer from the solvent to provide the (co)polymer matrix composite.

In the first method, the desired article is formed before the (co)polymer becomes miscible with the solvent and the phase separation is a thermally induced phase separation (TIPS) process.

In the TIPS process, elevated temperature is used to make a nonsolvent become a solvent for the (co)polymer, then the temperature is lowered returning the solvent to a nonsolvent for the (co)polymer. Effectively, the hot solvent becomes the pore former when sufficient heat is removed and it loses its solvating capacity. The solvent used in the thermal phase separation process can be volatile or nonvolatile.

Surprisingly, in the first method to make a (co)polymer matrix composite, the relatively high particle loadings allow a slurry to be made that can be shaped into a layer, that maintains its form as the solvent is heated to become miscible with the (co)polymer. The solvent used is normally volatile and is later evaporated.

Typically, the maximum particle loading that can be achieved in traditional particle-filled composites (dense (co)polymeric films, adhesives, etc.), is not more than about 40 to 60 vol. %, based on the volume of the particles and binder. Incorporating more than 60 vol. % particles into traditional particle-filled composites typically is not achievable because such high particle loaded materials cannot be processed via coating or extrusion methods and/or the resulting composite becomes very brittle.

Traditional composites also typically fully encapsulate the particles with binder, preventing access to the particle surfaces and minimizing potential particle-to-particle contact. Surprisingly, the high levels of solvent and the phase separated morphologies obtained with the methods described herein, enable relatively high particle loadings with relatively low amounts of high molecular weight binder. The through-porous. phase-separated morphologies also allow samples to be breathable at relatively low to relatively high particle concentrations. The high particle loading also helps minimize the formation of thin non-porous (co)polymer layer that can form during phase separation. Moreover, the (co)polymer matrix composites described herein are relatively flexible, and tend not to shed particles. Although not wanting to be bound by theory, it is believed that another advantage of embodiments of (co)polymer matrix composites described herein, is that the particles are not fully coated with binder enabling a high degree of particle surface contact, without masking due to the porous nature of the binder. It should be noted that compression of the layer can significantly enhance the particle-to-particle contact. The high molecular weight binder also does not readily flow in the absence of solvent, even at elevated temperatures (e.g., 135° C.).

In the first method using a TIPS process to make a (co)polymer matrix composite, the solvent used is normally nonvolatile, but in some exemplary embodiments, the solvent is advantageously selected to be a volatile solvent or may comprise a mixture of a least one non-volatile solvent and at least one volatile solvent.

If the particles are dense, typically the slurry is continuously mixed or blended to prevent or reduce settling or separation of the (co)polymer and/or particles from the solvent. In some embodiments, the slurry is degassed using techniques known in the art to remove entrapped air.

The slurry can be formed in to an article using techniques known in the art, including knife coating, roll coating (e.g., roll coating through a defined nip), and coating through any number of different dies having the appropriate dimensions or profiles.

In some embodiments of the first method, combining is conducted at at least one temperature below the melting point of the (co)polymer and below the boiling point of the solvent.

In some embodiments of the first method, heating is conducted at at least one temperature above the melting point of the miscible thermoplastic (co)polymer-solvent solution, and below the boiling point of the solvent.

In some embodiments of the first method, inducing phase separation is conducted at a temperature less than the melting point of the (co)polymer in the slurry. Although not wanting to be bound, it is believed that in some embodiments, solvents used to make a miscible blend with the (co)polymer can cause melting point depression in the (co)polymer. The melting point described herein includes below any melting point depression of the (co)polymer solvent system.

In some embodiments of the first method, the solvent is a blend of at least two individual solvents. In some embodiments, when the (co)polymer is a polyolefin (e.g., at least one of polyethylene or polypropylene), the solvent may be at least one of mineral oil, tetralin, decalin, 1,2-orthodichlorobenzene, cyclohexane-toluene mixture, dodecane, paraffin oil/wax, kerosene, p-xylene/cyclohexane mixture (1/1 wt./wt.), camphene, 1,2,4 trichlorobenzene, octane, orange oil, vegetable oil, castor oil, or palm kernel oil. In some embodiments, when the (co)polymer is polyvinylidene fluoride, the solvent is at least one of ethylene carbonate, propylene carbonate, or 1,2,3 triacetoxypropane.

In some embodiments of the first method, the (co)polymeric network structure may be formed during phase separation. In some embodiments, the (co)polymeric network structure is provided by an induced phase separation of a miscible thermoplastic (co)polymer-solvent solution. In some embodiments, the phase separation is induced thermally (e.g., via thermally induced phase separation (TIPS) by quenching to a lower temperature than used during heating). Cooling can be provided, for example, in air, liquid, or on a solid interface, and varied to control the phase separation. The (co)polymeric network structure may be inherently porous (i.e., have pores). The pore structure may be open, enabling fluid communication from an interior region of the (co)polymeric network structure to an exterior surface of the (co)polymeric network structure and/or between a first surface of the (co)polymeric network structure and an opposing second surface of the (co)polymeric network structure.

In some embodiments of the method described herein, the weight ratio of solvent to (co)polymer is at least 9:1. In some embodiments, the volume ratio of particles to (co)polymer is at least 9:1. In some embodiments, and for ease of manufacturing, it may be desirable to form a layer at room temperature. Typically, during the layer formation using phase separation, relatively small pores are particularly vulnerable to collapsing during solvent extraction. The relatively high particle to (co)polymer loading achievable by the methods described herein may reduce pore collapsing and yield a more uniform defect-free (co)polymer matrix composite.

In some embodiments, the first method further comprises removing at least a portion (in some embodiments, at least 5, 10, 15, 20, 25, 30, 35, 40, 45, 50, 55, 60, 65, 70, 75, 80, 85, 90, 95, 96, 97, 98, 99, 99.5, or even 100 percent by weight of the solvent, based on the weight of the solvent in the formed article) of the solvent from the formed article, after inducing phase separation of the thermoplastic (co)polymer from the solvent.

In some embodiments of the first method, at least 90 percent by weight of the solvent, based on the weight of the solvent in the formed article, is removed, wherein the formed article, before removing at least 90 percent by weight of the solvent, based on the weight of the solvent in the formed article, of the solvent has a first volume, wherein the formed article, after removing at least 90 percent by weight of the solvent, based on the weight of the solvent in the formed article, has a second volume, and wherein the difference between the first and second volume (i.e., (the first volume minus the second volume) divided by the first volume times 100) is less than 10 (in some embodiments, less than 9, 8, 7, 6, 5, 4, 3, 2, 1, 0.75, 0.5, or even less than 0.3) percent.

Volatile solvents can be removed from the (co)polymer matrix composite, for example, by allowing the solvent to evaporate from at least one major surface of the (co)polymer matrix composite. Evaporation can be aided, for example, by the addition of at least one of heat, vacuum, or air flow. Evaporation of flammable solvents can be achieved in a solvent-rated oven. If the first solvent, however, has a low vapor pressure, a second solvent, of higher vapor pressure, may be used to extract the first solvent, followed by evaporation of the second solvent. For example, in some embodiments, when mineral oil is used as a first solvent, isopropanol at elevated temperature (e.g., about 60° C.) or a blend of methyl nonafluorobutyl ether (C₄F₉OCH₃), ethylnonafluorobutyl ether (C₄F₉OC₂H₅), and trans-1,2-dichloroethylene (available under the trade designation “NOVEC 72DE” from 3M Company, St. Paul, Minn.) may be used as a second solvent to extract the first solvent, followed by evaporation of the second solvent. In some embodiments, when at least one of vegetable oil or palm kernel oil is used as the first solvent, isopropanol at elevated temperature (e.g., about 60° C.) may be used as the second solvent. In some embodiments, when ethylene carbonate is used as the first solvent, water may be used as the second solvent.

In some embodiments of the first method, the article has first and second major surfaces with ends perpendicular to the first and second major surfaces, and the ends are unrestrained (i.e., without the need for restraints during extraction) during the solvent removal. This can be done, for example, by drying a portion of a layer without restraint in an oven. Continuous drying can be achieved, for example, by drying a long portion of a layer supported on a belt as it is conveyed through an oven. Alternatively, to facilitate removal of non-volatile solvents, for example, a long portion of a layer can be continuously conveyed through a bath of compatible volatile solvent thereby exchanging the solvents and allowing the layer to be subsequently dried without restraint. Not all the non-volatile solvent, however, need be removed from the layer during the solvent exchange. Small amounts of non-volatile solvents may remain and act as a plasticizer to the (co)polymer.

In some embodiments of the first method, the formed, phase separated article after the solvent removal, has a porosity of at least 5 (in some embodiments, at least 10, 20, 30, 35, 40, 45, 50, 55, 60, 65, 70, 75, 80, 85, or even at least 90; in some embodiments, in a range from 25 to 90) percent. This porosity is caused by the phase separation of the (co)polymer from the solvent, which initially leaves no unfilled voids, as the pores in the (co)polymer matrix composite are filled with solvent. After the solvent is completely or partly removed, void spaces in the (co)polymer matrix composite are exposed. The particle-to-particle interactions can minimize the collapse or deformation of the porous (co)polymer matrix composite from capillary-induced negative pressures from the solvent drying process.

In some embodiments of the first method, no solvent is removed from the formed article (even after inducing phase separation of the thermoplastic (co)polymer from the solvent). This can be accomplished, for example, by using a non-volatile solvent (e.g., mineral oil or wax) and not completing the extraction/evaporation step.

### Second Method

In another aspect, the present disclosure describes a second method of making (co)polymer matrix composites described herein, the method comprising:

combining (e.g., mixing or blending) a thermoplastic (co)polymer, a solvent for the thermoplastic (co)polymer, a plurality of thermally-conductive particles, and a plurality of magnetic particles to form a suspension of magnetic particles in a miscible thermoplastic (co)polymer-solvent solution;

inducing phase separation of the thermoplastic (co)polymer from the solvent; and

removing at least a portion of the solvent to provide the (co)polymer matrix composite.

In the second method, the (co)polymer is miscible with the solvent before the desired article is formed. In the second method, phase separation is achieved via solvent induced phase separation (SIPS) using a wet or dry process, or thermally induced phase separation methods.

In the SIPS wet process, the solvent dissolving the (co)polymer is exchanged with a nonsolvent to induce phase separation. The new exchanging solvent in the system becomes the pore former for the (co)polymer. In the SIPS dry process, the solvent dissolving the (co)polymer is evaporated to induce phase separation. In the dry process, a nonsolvent is also solubilized in the solution by the solvent dissolving the (co)polymer. This nonsolvent for the (co)polymer becomes the pore former for the (co)polymer as the solubilizing solvent evaporates. The process is considered a “dry process” because no additional exchange liquids are used. The nonsolvent is also normally volatile but has a boiling point at least 30° C. lower than the solvent.

In the second method to make a (co)polymer matrix composite by the wet or dry SIPS process, the solvents are normally nonvolatile for the wet process and volatile for the dry process. However, in some exemplary embodiments of either the wet or dry SIPS process, the solvent may advantageously comprise a mixture of a least one non-volatile solvent and at least one volatile solvent.

In some embodiments, the second method further comprises adding the thermally-conductive particles and/or the magnetic particles and the optional magnetic particles to the miscible (co)polymer-solvent solution, prior to phase separation. The (co)polymeric network structure may be formed during the phase separation of the process. In some embodiments, the (co)polymeric network structure is provided via an induced phase separation of a miscible thermoplastic (co)polymer-solvent solution. In some embodiments, the phase separation is induced thermally (e.g., via thermally induced phase separation (TIPS) by quenching to lower temperature), chemically (e.g., via solvent induced phase separation (SIPS) by substituting a poor solvent for a good solvent), or change in the solvent ratio (e.g., by evaporation of one of the solvents).

Other phase separation or pore formation techniques known in the art, such as discontinuous (co)polymer blends (also sometimes referred to as (co)polymer assisted phase inversion (PAPI)), moisture induced phase separation, or vapor induced phase separation, can also be used. The (co)polymeric network structure may be inherently porous (i.e., have pores). The pore structure may be open, enabling fluid communication from an interior region of the (co)polymeric network structure to an exterior surface of the (co)polymeric network structure and/or between a first surface of the (co)polymeric network structure and an opposing second surface of the (co)polymeric network structure.

In some embodiments of the second method, the (co)polymer in the miscible thermoplastic (co)polymer-solvent solution has a melting point, wherein the solvent has a boiling point, and wherein combining is conducted at at least one temperature above the melting point of the miscible thermoplastic (co)polymer-solvent solution, and below the boiling point of the solvent.

In some embodiments of the second method, the (co)polymer in the miscible thermoplastic (co)polymer-solvent solution has a melting point, and wherein inducing phase separation is conducted at at least one temperature less than the melting point of the (co)polymer in the miscible thermoplastic (co)polymer-solvent solution. The thermoplastic (co)polymer-solvent mixture may be heated to facilitate the dissolution of the thermoplastic (co)polymer in the solvent. After the thermoplastic (co)polymer has been phase separated from the solvent, at least a portion of the solvent may be removed from the (co)polymer matrix composite using techniques known in the art, including evaporation of the solvent or extraction of the solvent by a higher vapor pressure, second solvent, followed by evaporation of the second solvent.

In some embodiments, in a range from 10 to 100 (in some embodiments, in a range from 20 to 100, 30 to 100, 40 to 100, 50 to 100, 60 to 100, 70 to 100, 80 to 100, 90 to 100, 95 to 100, or even 98 to 100) percent by weight of the solvent, and second solvent, if used, may be removed from the (co)polymer matrix composite.

Typically, in the phase separation process, the blended mixture is formed in to a layer prior to solidification of the (co)polymer. The (co)polymer is dissolved in solvent (that allows formation of miscible thermoplastic-solvent solution), and the magnetic particles dispersed to form a blended mixture, that is formed into an article (e.g., a layer), followed by phase separation (e.g., temperature reduction for TIPS, solvent evaporation or solvent exchange with nonsolvent for SIPS). The layer-forming may be conducted using techniques known in the art, including, knife coating, roll coating (e.g., roll coating through a defined nip), and extrusion (e.g., extrusion through a die (e.g., extrusion through a die having the appropriate layer dimensions (i.e., width and thickness of the die gap))). In one exemplary embodiment, the mixture has a paste-like consistency and is formed in to a layer by extrusion (e.g., extrusion through a die having the appropriate layer dimensions (i.e., width and thickness of the die gap)).

After forming the slurry in to a layer, where the thermoplastic (co)polymer is miscible in its solvent, the (co)polymer is then induced to phase separate. Several techniques may be used to induce phase separation, including at least one of thermally induced phase separation or solvent induced phase separation. Thermally induced phase separation may occur when the temperature at which induced phase separation is conducted is lower than the combining temperature of the (co)polymer, solvent, and magnetic particles. This may be achieved by cooling the miscible (co)polymer-solvent solution, if combining is conducted near room temperature, or by first heating the miscible (co)polymer-solvent solution to an elevated temperature (either during combining or after combining), followed by decreasing the temperature of the miscible (co)polymer-solvent solution, thereby inducing phase separation of the thermoplastic (co)polymer.

In both cases, the cooling may cause phase separation of the (co)polymer from the solvent. Solvent induced phase separation can be conducted by adding a second solvent, a poor solvent for the (co)polymer, to the miscible (co)polymer-solvent solution or may be achieved by removing at least a portion of the solvent of the miscible (co)polymer-solvent solution (e.g., evaporating at least a portion of the solvent of the miscible (co)polymer-solvent solution), thereby inducing phase separation of the (co)polymer. Combination of phase separation techniques (e.g., thermally induced phase separation and solvent induced phase separation), may be employed.

Thermally induced phase separation, may be advantageous, as it also facilitates the dissolution of the (co)polymer when combining is conducted at an elevated temperature. In some embodiments, thermally inducing phase separation is conducted at at least one temperature in a range from 5 to 300 (in some embodiments, in a range from 5 to 250, 5 to 200, 5 to 150, 15 to 300, 15 to 250, 15 to 200, 15 to 130, or even 25 to 110) ° C. below the combining temperature.

After inducing phase separation, at least a portion of the solvent may be removed, thereby forming a porous (co)polymer matrix composite layer having a (co)polymeric network structure and an magnetic material distributed within the thermoplastic (co)polymer network structure.

The solvent may be removed by evaporation, high vapor pressure solvents being particularly suited to this method of removal. If the first solvent, however, has a low vapor pressure, a second solvent, of higher vapor pressure, may be used to extract the first solvent, followed by evaporation of the second solvent. In some embodiments, in a range from 10 to 100 (in some embodiments, in a range from 20 to 100, 30 to 100, 40 to 100, 50 to 100, 60 to 100, 70 to 100, 80 to 100, 90 to 100, 95 to 100, or even 98 to 100) percent by weight of the solvent, and second solvent, if used, may be removed from the (co)polymer matrix composite.

### Optional Additional Processing Steps

After either the inducing phase separation or after the removing of at least a portion of the solvent step, the formed thermoplastic polymer network structure may be collapsed in order to densify the (co)polymer matrix composite. This may be achieved by applying at least one of a compressive force and a tensile force to the (co)polymer matrix composite, e.g., a (co)polymer matrix composite sheet. In some embodiments, the method of making the (co)polymer matrix composite further includes applying at least one of a compressive force and a tensile force, after the removing the solvent step, thereby densifying the (co)polymer matrix composite sheet.

The at least one of a compressive force and a tensile force may be applied by techniques known in the art. For example, a compressive force can be achieved by urging the (co)polymer matrix composite, e.g., (co)polymer matrix composite sheet, through the nip of a pair of nip rolls, e.g., calendaring, the rolls having a gap setting less than the thickness of the (co)polymer matrix composite. Unlike conventional composites, which do not have a thermoplastic polymer network structure, the final density of the (co)polymer matrix composite can be controlled depending on the degree to which the thermoplastic polymer network structure is collapsed, e.g., the nip thickness relative to the (co)polymer matrix composite thickness, in the previous compressive force example.

In another example, a tensile force can be applied to the (co)polymer matrix composite, e.g., (co)polymer matrix composite sheet, via a tentering process. Unlike conventional composites, which do not have a thermoplastic polymer, network structure, the final density of the (co)polymer matrix composite can be controlled depending on the degree the thermoplastic network, structure is collapsed, e.g., the amount of stretching of the (co)polymer matrix composite sheet in the tentering process in the previous tensile force example.

In some embodiments, the first and second methods further comprise compressing the (co)polymer matrix composite. That is, after inducing phase separation, the formed (co)polymeric network structure may be compressed, for example, to tune the air flow resistance of the (co)polymer matrix composite. Compression of the (co)polymer matrix composite may be achieved, for example, by conventional calendaring processes known in the art.

In some embodiments, where the network structure is plastically deformed by at least a compressive force, vibratory energy may be imparted during the application of the compressive force. In some of these embodiments, the (co)(co)polymer matrix composite is in the form of a strip of indefinite length, and the applying of a compressive force step is performed as the strip passes through a nip. A tensile loading may be applied during passage through such a nip. For example, the nip may be formed between two rollers, at least one of which applies the vibratory energy; between a roller and a bar, at least one of which applies the vibratory energy; or between two bars, at least one of which applies the vibratory energy. The applying of the compressive force and the vibratory energy may be accomplished in a continuous roll-to-roll fashion, or in a step-and-repeat fashion. In other embodiments, the applying a compressive force step is performed on a discrete layer between, for example, a plate and a platen, at least one of which applies the vibratory energy. In some embodiments, the vibratory energy is in the ultrasonic range (e.g., 20 kHz), but other ranges are considered to be suitable. For further details regarding plastically deforming the network structure, see co-pending application having U.S. Ser. No. 62/578,732, filed Oct. 30, 2017, the disclosure of which is incorporated by reference.

In some embodiments, the density of the compressed (co)polymer matrix composite is at least 1 (in some embodiments, at least 2.5, or even at least 1.75; in some embodiments, in the range from 1 to 1.75, or even 1 to 2.5) g/cm³ after compression.

In some embodiments, compressing the (co)polymeric matrix composite increases its density by increasing the particle-to-particle contact. This increase in density can increase the amount of magnetic per unit volume.

In some embodiments, (co)polymer matrix composite described herein can be wrapped around a 0.5 mm (in some embodiments, 0.6 mm, 0.7 mm, 0.8 mm, 0.9 mm, 1 mm, 2 mm, 3 mm, 4 mm, 5 mm, 1 cm, 5 cm, 10 cm, 25 cm, 50 cm, or even 1 meter) rod without breaking.

The process used to fabricate the (co)polymer matrix composite, e.g., (co)polymer matrix composite sheet, and/or to collapse the (co)polymer matrix composite to densify the (co)polymer matrix composite, may also, in some embodiments, orient the soft, ferromagnetic particulate material, e.g., soft, ferromagnetic particulate flake material. When the (co)polymer matrix composite is in the form of a (co)polymer matrix composite sheet having a first major surface, the method of making a (co)polymer matrix composite may further include orienting the anisotropic, soft, ferromagnetic particulate material such that the maximum length dimension of the anisotropic, soft, ferromagnetic particulate material are oriented to be within at least 25 degrees, within at least 20 degrees, within at least 15 degrees or even within at least 10 degrees of the adjacent first major surface of the (co)polymer matrix composite sheet.

In some embodiments, the maximum length dimension of the anisotropic, soft, ferromagnetic particulate material may be oriented in the machine direction of the process used to fabricate (co)polymer matrix composite sheet. When the (co)polymer matrix composite is in the form of a (co)polymer matrix composite sheet having a first major surface and the soft, ferromagnetic particulate material is soft, ferromagnetic particulate flake material, each flake having a first major surface, the method of making a (co)polymer matrix composite may further include orienting the soft, ferromagnetic particulate flake material such that a majority of the first major surfaces of the flakes are oriented to be within at least 25 degrees, within at least 20 degrees, at least 15 degrees or even within at least 10 degrees of the adjacent first major surface of the (co)polymer matrix composite sheet. In some embodiments, the first major surfaces of the soft, ferromagnetic particulate flake material may be oriented in the machine direction of the process used to fabricate (co)polymer matrix composite sheet.

Various unexpected results and advantages are obtained in exemplary embodiments of the disclosure. These and other unexpected results and advantages are within the scope of the following exemplary embodiments.

### LISTING OF EXEMPLARY EMBODIMENTS

1A. A (co)polymer matrix composite comprising:

a porous (co)polymeric network structure; and

a plurality of thermally-conductive particles, and a plurality of magnetic particles distributed within the (co)polymeric network structure,

wherein the thermally-conductive particles and magnetic particles are present in a range from 15 to 99 (in some embodiments, in a range from 25 to 98, 50 to 98, 75 to 98, or even 93 to 97) weight percent, based on the total weight of magnetic particles and the (co)polymer (excluding any solvent.

2A. The (co)polymer matrix composite of Exemplary Embodiment 1A, wherein the (co)polymer matrix composite has a density of at least 0.3 (in some embodiments, in a range from 0.3 to 4.0, 0.4 to 3.9, 0.5 to 3,8, or even 0.6 to 3.7 g/cm³.

3A. The (co)polymer matrix composite of any preceding Exemplary Embodiment, wherein the (co)polymer matrix composite has a porosity of at least 5 (in some embodiments, in a range from 10 to 80, 20 to 70, or even 30 to 60) percent.

4A. The (co)polymer matrix composite of any preceding Exemplary Embodiment, wherein the thermally-conductive particles comprise at least one of electrically non-conductive particles or electrically-conductive particles, further wherein the electrically non-conductive particles are ceramic particles selected from the group consisting of boron nitride, aluminum trihydrate, silicon carbide, silicon nitride, metal oxides, metal nitrides, and combinations thereof; and the electrically-conductive particles are carbon particles selected from the group consisting of carbon black, graphite, graphene and combinations thereof, and/or metal particles selected from the group consisting of aluminum, copper, nickel, silver, platinum, gold, and combinations thereof; additionally wherein the magnetic particles comprise at least one of the following soft metallic alloys: Fe-based amorphous, Fe-based nanocrystalline, Fe-based nanocrystalline nitrides, Fe—Al—Si, Fe—Cr, Fe—Si, Fe—Si—B, Fe—Si—Cr, Fe—Co—B, Ni—Fe, Ni—Fe—Mo, Ni—Si, Co—Nb—Zr, boron based amorphous alloys; magnetically soft ferrites such as: iron oxide (magnetite), Ni—Zn, Mn—Zn; magnetically hard metallic alloys such as: Fe—Cr—Co, Nd—Fe—B, Sm—Co, Sm—Fe—N, Al—Ni—Co, Cu—Ni—Fe, Cu—Ni—Fe—Co, steels with a ferritic or martensitic crystal structures; and hard ferrites such as: barium ferrite, strontium ferrite, or a combination thereof.

5A. The (co)polymer matrix composite of any Preceding Exemplary Embodiment, wherein the thermally-conductive particles comprise first and second, different (i.e., different thermal conductivity, composition, particle size or microstructure) thermally-conductive particles.

6A. The (co)polymer matrix composite of Exemplary Embodiment 5A, wherein the first thermally-conductive particles have an average particle size (average length of longest dimension) in a range from 500 nm to 7000 micrometers (in some embodiments, in a range from 70 micrometers to 300 micrometers, 300 micrometers to 800 micrometers, 800 micrometers to 1500 micrometers, or even 1500 micrometers to 7000 micrometers) and the second thermally-conductive particles have an average particle size (average length of longest dimension) in a range 500 nm to 7000 micrometers (in some embodiments, in a range from 70 micrometers to 300 micrometers, 300 micrometers to 800 micrometers, 800 micrometers to 1500 micrometers, or even 1500 micrometers to 7000 micrometers).

7A. The (co)polymer matrix composite of any Preceding Exemplary Embodiment, wherein the magnetic particles comprise first and second, different (i.e., different magnetic properties, composition, particle size or microstructure) magnetic particles.

8A. The (co)polymer matrix composite of Exemplary Embodiment 7A, wherein the first magnetic particles have an average particle size (average length of longest dimension) in a range from 500 nm to 7000 micrometers (in some embodiments, in a range from 70 micrometers to 300 micrometers, 300 micrometers to 800 micrometers, 800 micrometers to 1500 micrometers, or even 1500 micrometers to 7000 micrometers) and the second magnetic particles have an average particle size (average length of longest dimension) in a range 500 nm to 7000 micrometers (in some embodiments, in a range from 70 micrometers to 300 micrometers, 300 micrometers to 800 micrometers, 800 micrometers to 1500 micrometers, or even 1500 micrometers to 7000 micrometers).

9A. The (co)polymer matrix composite of any of Exemplary Embodiments 7A to 8A, wherein the first magnetic particles are present in a range from 15 to 99 (in some embodiments, in a range from 25 to 98, 50 to 98, 75 to 98, or even 93 to 97) weight percent, and wherein the second magnetic particles are present in a weight fraction in a range from 15 to 99 (in some embodiments, in a range from 25 to 98, 50 to 98, 75 to 98, or even 93 to 97) weight percent, based on the total weight of the first and second magnetic particles.

10A. The (co)polymer matrix composite of any preceding Exemplary Embodiment, wherein the porous (co)polymeric network structure comprises at least one of polyurethane, polyester, polyamide, polyether, polycarbonate, polyimide, polysulfone, polyethersulfone, polyphenylene oxide, polyacrylate, poly(meth)acrylate, polyacrylonitrile, polyolefin, styrene or styrene-based random and block (co)polymer, chlorinated (co)polymer, fluorinated (co)polymer, or (co)polymers of ethylene and chlorotrifluoroethylene.

11A. The (co)polymer matrix composite of any preceding Exemplary Embodiment, wherein the porous (co)polymeric network structure comprises a phase separated plurality of interconnected morphologies (e.g., at least one of fibrils, nodules, nodes, open cells, closed cells, leafy laces, strands, nodes, spheres, or honeycombs).

12A. The (co)polymer matrix composite of any preceding Exemplary Embodiment, wherein the porous (co)polymeric network structure comprises a (co)polymer having a number average molecular weight in a range from of 5×10⁴ to 1×10⁷ (in some embodiments, in a range from 1×10⁶ to 8×10⁶, 2×10⁶ to 6×10⁶, or even 3×10⁶ to 5×10⁶) g/mol.

13A. The (co)polymer matrix composite of any preceding Exemplary Embodiment, wherein the (co)polymer matrix composite is in the form of a layer having a thickness in a range from 50 to 7000 micrometers.

14A. The (co)polymer matrix composite of any preceding Exemplary Embodiment, wherein the porous (co)polymeric network structure is produced by an induced phase separation of a miscible thermoplastic (co)polymer-solvent solution.

15A. The (co)polymer matrix composite of Exemplary Embodiment 14A, wherein induced phase separation is at least one of thermally induced phase separation and solvent induced phase separation.

16A. The (co)polymer matrix composite of any preceding Exemplary Embodiment, having first and second planar, opposed major surfaces.

17A. The (co)polymer matrix composite of any preceding Exemplary Embodiment, having first and second opposed major surfaces, wherein the first major surface is nonplanar (e.g., curved or protrusions with no planar surface there between).

18A. The (co)polymer matrix composite of either Exemplary Embodiment 16A or 17A, wherein the first major surface has first protrusions extending outwardly from the first major surface. In some embodiments, the protrusions are integral with the first major surface.

19A. The (co)polymer matrix composite of Exemplary Embodiment 18A, wherein the first protrusions are at least one of a post, a rail, a hook, a pyramid, a continuous rail, a continuous multi-directional rail, a hemisphere, a cylinder, or a multi-lobed cylinder.

20A. The (co)polymer matrix composite of any of Exemplary Embodiments 16A to 19A, wherein the first major surface has first depressions extending into the first major surface.

21A. The (co)polymer matrix composite of Exemplary Embodiment 20A, wherein the first depressions are at least one of a groove, a slot, an inverted pyramid, a hole (including a thru or blind hole), or a dimple.

22A. The (co)polymer matrix composite of any of Exemplary Embodiments 18A to 21A, wherein the second major surface has second protrusions extending outwardly from the second major surface.

23A. The (co)polymer matrix composite of Exemplary Embodiment 22A, wherein the second protrusions are at least one of a post, a rail, a hook, a pyramid, a continuous rail, a continuous multi-directional rail, a hemisphere, a cylinder, or a multi-lobed cylinder.

24A. The (co)polymer matrix composite of any of Exemplary Embodiments 18A to 23A, wherein the second major surface has second depressions extending into the second major surface.

25A. The (co)polymer matrix composite of Exemplary Embodiment 24A, wherein the second depressions are at least one of a groove, a slot, an inverted pyramid, a hole (including a thru or blind hole), or a dimple.

26A. The (co)polymer matrix composite of any preceding Exemplary Embodiment, further comprising a reinforcement (e.g., attached to the (co)polymer matrix composite, partial therein, and/or therein).

27A. The (co)polymer matrix composite of any preceding Exemplary Embodiment, that can be wrapped around a 0.5 mm (in some embodiments, 0.6 mm, 0.7 mm, 0.8 mm, 0.9 mm, 1 mm, 2 mm, 3 mm, 4 mm, 5 mm, 1 cm, 5 cm, 10 cm, 25 cm, 50 cm, or even 1 meter) rod without breaking.

28A. The (co)polymer matrix composite of any of Exemplary Embodiments 1A to 12A, wherein the thermally-conductive particles and the magnetic particles are present in a single layer.

29A. The (co)polymer matrix composite of any of Exemplary Embodiments 1A to 12A, wherein the thermally-conductive particles are present in a first layer, and the magnetic particles are present in a second layer adjacent to the first layer, optionally wherein the second layer adjoins the first layer.

30A. The (co)polymer matrix composite of any of Exemplary Embodiments 1A to 12A, wherein the thermally-conductive particles are present in a first layer having opposed first and second major surfaces, and the magnetic particles are present in a second layer overlaying and adjacent to the first major surface of the first layer, and a third layer overlaying and adjacent to the second major surface of the first layer, optionally wherein the second layer adjoins the first major surface, and the third layer adjoins the second major surface.

31A. The (co)polymer matrix composite of any of Exemplary Embodiments 1A to 12A, wherein the magnetic particles are present in a first layer having opposed first and second major surfaces, and the thermally-conductive particles are present in a second layer overlaying and adjacent to the first major surface of the first layer and a third layer overlaying and adjacent to the second major surface of the first layer, optionally wherein the second layer adjoins the first major surface, and the third layer adjoins the second major surface.

32A. The (co)polymer matrix composite of any preceding Exemplary Embodiment, comprising at least one of a viscosity modifier (e.g., fumed silica, block (co)polymers, and wax), a plasticizer, a thermal stabilizer (e.g., such as available, for example, under the trade designation “IRGANOX 1010” from BASF, Ludwigshafen, Germany), an antimicrobial (e.g., silver and quaternary ammonium), a flame retardant, an antioxidant, a dye, a pigment, or an ultraviolet (UV) stabilizer.

1B. A method of making the (co)polymer matrix composite of any preceding Exemplary Embodiment, the method comprising:

combining (e.g., mixing or blending) a thermoplastic (co)polymer, a solvent, a plurality of thermally-conductive particles, a plurality of magnetic particles and optionally a plurality of magnetic particles to provide a slurry;

forming the slurry in to an article (e.g., a layer);

heating the article in an environment to retain at least 90 (in some embodiments, at least 91, 92, 93, 94, 95, 96, 97, 98, 99, or even at least 99.5) percent by weight of the solvent in the article, based on the weight of the solvent in the article, and solubilize at least 50 (in some embodiments, at least 55, 60, 65, 70, 75, 80, 85, 90, 95, 96, 97, 98, 99, or even 100) percent of the thermoplastic (co)polymer, based on the total weight of the thermoplastic (co)polymer; and

inducing phase separation of the thermoplastic (co)polymer from the solvent to provide the (co)polymer matrix composite.

2B. The method of Exemplary Embodiment 1B, further comprising removing at least a portion (in some embodiments, at least 5, 10, 15, 20, 25, 30, 35, 40, 45, 50, 55, 60, 65, 70, 75, 80, 85, 90, 95, 96, 97, 98, 99, 99.5, or even 100 percent by weight of the solvent, based on the weight of the solvent in the formed article) of the solvent from the formed article after inducing phase separation of the thermoplastic (co)polymer from the solvent.

3B. The method of Exemplary Embodiment 2B, wherein at least 90 percent by weight of the solvent, based on the weight of the solvent in the formed article, is removed, wherein the formed article, before removing at least 90 percent by weight of the solvent, based on the weight of the solvent in the formed article, of the solvent has a first volume, wherein the formed article, after removing at least 90 percent by weight of the solvent, based on the weight of the solvent in the formed article, has a second volume, and wherein the difference between the first and second volume (i.e., (the first volume minus the second volume) divided by the first volume times 100) is less than 10 (in some embodiments, less than 9, 8, 7, 6, 5, 4, 3, 2, 1, 0.75, 0.5, or even less than 0.3) percent.

4B. The method of Exemplary Embodiment 3B, wherein the article has first and second major surfaces with ends perpendicular to the first and second major surfaces, and where the ends are unrestrained during the solvent removal.

5B. The method of either Exemplary Embodiment 3B or 4B, wherein the formed article after the solvent removal, has a porosity at least 5 (in some embodiments, at least 10, 20, 30, 35, 40, 45, 50, 55, 60, 65, 70, 75, 80, 85, or even at least 90; in some embodiments, in a range from 25 to 90) percent.

6B. The method of Exemplary Embodiment 1B, wherein no solvent is removed from the formed article (even after inducing phase separation of the thermoplastic (co)polymer from the solvent).

7B. The method of any preceding B Exemplary Embodiment, wherein inducing phase separation includes thermally induced phase separation.

8B. The method of any preceding B Exemplary Embodiment, wherein the (co)polymer in the slurry has a melting point, wherein the solvent has a boiling point, and wherein combining is conducted below the melting point of the (co)polymer in the slurry, and below the boiling point of the solvent.

9B. The method of any preceding B Exemplary Embodiment, wherein the (co)polymer in the slurry has a melting point, and wherein inducing phase separation is conducted at less than the melting point of the (co)polymer in the slurry.

10B. The method of any preceding B Exemplary Embodiment, further comprising compressing the (co)polymer matrix composite.

11B. The method of any of Exemplary Embodiments 1B to 9B, further comprising applying vibratory energy to the (co)polymer matrix composite simultaneously with the applying a compressive force.

12B. The method of any preceding B Exemplary Embodiment, wherein the porous (co)polymeric network structure comprises at least one of polyacrylonitrile, polyurethane, polyester, polyamide, polyether, polycarbonate, polyimide, polysulfone, polyethersulfone, polyphenylene oxide, polyacrylate, poly(meth)acrylate, polyolefin, styrene or styrene-based random and block (co)polymer, chlorinated (co)polymer, fluorinated (co)polymer, or (co)polymers of ethylene and chlorotrifluoroethylene.

13B. The method of any preceding B Exemplary Embodiment, wherein the porous (co)polymeric network structure comprises a plurality of interconnected morphologies (e.g., at least one of fibrils, nodules, nodes, open cells, closed cells, leafy laces, strands, nodes, spheres, or honeycombs).

14B. The method of any preceding B Exemplary Embodiment, wherein the porous (co)polymeric network structure is produced by an induced phase separation of a miscible thermoplastic (co)polymer-solvent solution.

15B. The method of Exemplary Embodiment 14B, wherein inducing phase separation includes thermally induced phase separation.

1C. A method of making the (co)polymer matrix composite of any preceding A Exemplary Embodiment, the method comprising:

combining (e.g., mixing or blending) a thermoplastic (co)polymer, a solvent for the thermoplastic (co)polymer, a plurality of thermally-conductive particles, a plurality of magnetic particles and optionally a plurality of magnetic particles to form a suspension of magnetic particles in a miscible thermoplastic (co)polymer-solvent solution;

inducing phase separation of the thermoplastic (co)polymer from the solvent; and

removing at least a portion of the solvent to provide the (co)polymer matrix composite.

2C. The method of Exemplary Embodiment 1C, wherein inducing phase separation includes at least one of thermally induced phase separation or solvent induced phase separation.

3C. The method of Exemplary Embodiment 1C, wherein the (co)polymer in the miscible thermoplastic (co)polymer-solvent solution has a melting point, wherein the solvent has a boiling point, and wherein combining is conducted above the melting point of the miscible thermoplastic (co)polymer-solvent solution, and below the boiling point of the solvent.

4C. The method of any preceding C Exemplary Embodiment, wherein the (co)polymer in the miscible thermoplastic (co)polymer-solvent solution has a melting point, and wherein inducing phase separation is conducted at less than the melting point of the (co)polymer in the miscible thermoplastic (co)polymer-solvent solution.

5C. The method of any preceding C Exemplary Embodiment, further comprising compressing the (co)polymer matrix composite.

6C. The method of any of Exemplary Embodiments 1C to 4C, further comprising applying vibratory energy to the (co)polymer matrix composite simultaneously with the applying a compressive force.

7C. The method of any preceding C Exemplary Embodiment, wherein the porous (co)polymeric network structure comprises at least one of polyacrylonitrile, polyurethane, polyester, polyamide, polyether, polycarbonate, polyimide, polysulfone, polyethersulfone, polyphenylene oxide, polyacrylate, poly(meth)acrylate, polyolefin, styrene or styrene-based random and block (co)polymer, chlorinated (co)polymer, fluorinated (co)polymer, or (co)polymers of ethylene and chlorotrifluoroethylene.

8C. The method of any preceding C Exemplary Embodiment, wherein the porous (co)polymeric network structure comprises a plurality of interconnected morphologies (e.g., at least one of fibrils, nodules, nodes, open cells, closed cells, leafy laces, strands, nodes, spheres, or honeycombs).

1D. An article (e.g., thermal interface material, a thermally initiated fuse and a fire stop device) comprising the (co)polymer matrix composite of any preceding A Exemplary Embodiment.

The operation of the present disclosure will be further described with regard to the following detailed examples. These examples are offered to further illustrate the various specific and preferred embodiments and techniques. It should be understood, however, that many variations and modifications may be made while remaining within the scope of the present disclosure.

### EXAMPLES

These Examples are merely for illustrative purposes and are not meant to be overly limiting on the scope of the appended claims. Notwithstanding that the numerical ranges and parameters setting forth the broad scope of the present disclosure are approximations, the numerical values set forth in the specific examples are reported as precisely as possible. Any numerical value, however, inherently contains certain errors necessarily resulting from the standard deviation found in their respective testing measurements. At the very least, and not as an attempt to limit the application of the doctrine of equivalents to the scope of the claims, each numerical parameter should at least be construed in light of the number of reported significant digits and by applying ordinary rounding techniques.

### Test Methods

### Air Flow Resistance Test

Air flow resistance was measured using a densometer (obtained as Model 4110 from Gurley Precision Instruments, Troy, N.Y.) with a timer (obtained as Model 4320 from Gurley Precision Instruments). A sample was clamped in the tester. The timer and photo eye were reset and the cylinder was released, allowing air to pass through a 1 square inch (6.5 cm²) circle with a constant force of 4.88 inches (12.4 cm) of water (1215 N/m²). The time to pass 50 mL of air was recorded.

In some cases, the air flow resistance was normalized to that of a 500-micrometer thick film by dividing by the film thickness in micrometers and multiplying by 500 micrometers. Film thickness was measured as described below in the section “Method for Density and Porosity.”

### Bubble Point Pressure Test

Bubble point pressure is a commonly used technique to characterize the largest pore in a porous membrane. This technique is a modification to ASTM F316-03 (2006), “Standard Test Methods for Pore Size Characteristics of Membrane Filters by Bubble Point and Mean Flow Pore Test,” the entire disclosure of which is incorporated herein by reference, and includes an automated pressure controller and flow meter to quantify when the bubble point pressure had been reached.

Discs 47 mm in diameter were cut and samples soaked in IPA to fully fill and wet out the pores within the sample. The wet samples were then placed in a holder (47 mm; Stainless Holder Part #2220 from Pall Corporation (Port Washington, N.Y.). Pressure was slowly increased on the top of the sample using a pressure controller and gas flow was measured on the bottom with a gas flow meter. The pressure was recoded when there was a significant increase in flow from the baseline flow rate. This was reported as the bubble point pressure pounds per square inch (psi) (centimeters of mercury, cm Hg or Pascals, Pa).

The pore size was calculated according of the ASTM test method using the following equation:

Limiting Pore Diameter (μm)=(Surface Tension in dynes/cm*0.415)/(Pressure in psi)

The factor of 0.415 was included since the pressure was in units of psi. A surface tension of 21.68 dynes/cm was used for the IPA.

### Density and Porosity Test

The density of a sample was calculated using a method similar to ASTM F-1315-17 (2017), “Standard Test Method for Density of a Sheet Gasket Material,” the entire disclosure of which is incorporated herein by reference, by cutting a 47 mm diameter disc, weighing the disc on an analytical balance of suitable resolution (typically 0.0001 gram), and measuring the thickness of the disc on a thickness gauge (obtained as Model 49-70 from Testing Machines, Inc. (New Castle, Del.) with a dead weight of 7.3 psi (50.3 KPa) and a flat anvil of 0.63 inch (1.6 cm) diameter, with a dwell time of about 3 seconds and a resolution of +/−0.0001 inch. The density was then calculated by dividing the mass by the volume, which was calculated from the thickness and diameter of the sample. With the known densities and weight fractions of the components of the (co)polymer matrix composite, the theoretical density of the (co)polymer matrix composite was calculated by the rule of mixtures. Using the theoretical density and the measured density, the porosity was calculated as:

Porosity=[1−(measured density/theoretical density)]×100.

### Thermal Conductivity Test

The thermal conductivity of the films was measured according to ASTM D5470 (“Standard Test Method for Thermal Transmission Properties of Thermally Conductive Electrical Insulation Materials”), the entire disclosure of which is incorporated herein by reference, using the Thermal Interface Material Tester Model TIM1300 from AnalysisTech (Wakefield, Mass.). 33 mm discs were cut out of the densified squares using a hole punch. The test temperature was 50° C. and the applied test pressure was set to 100 psi. The instruments' thickness gauge was used to measure the thickness of the sample during testing. A thin layer of thermal grease (Thermal Grease 120 Series, Wakefield Thermal Solutions (Pelham, N.H.) is applied to the samples before placing them into the TIM tester to reduce the contact resistance between test surfaces and sample surfaces (increased surface wet-out).

### Static Magnetic Properties—Magnetic Test I

(co)polymer matrix composite samples were cut in to 6 mm disks prior to the magnetic measurements. A vibrating sample magnetometer (obtained as 7400-S from Lake Shore Cryotronics (Westerville, Ohio) was used to record magnetic hysteresis loops (M-H curves). The magnetizing field H was applied in the plane of the samples. The magnetic field span was set to H=±4 kOe and saturation magnetization Ms was measured at full saturation (|H|=4 kOe). Magnetizing field H was measured with step of 0.14 Oe and coercivity field Hc was defined in vicinity of M=0 via linear fitting based on 6 points on the M-H curve adjacent to M=0.

### Dynamic Magnetic Properties—Magnetic Test II

(co)polymer matrix composite samples were cut in to toroids with outer diameter of 18 mm and inner diameter of 5 mm. A magnetic test fixture (obtained as 16454A from Keysight Technologies (Santa Clara, Calif.) and impedance meter (obtained as E4990A from Keysight Technologies) were used to measure real and imaginary part of relative magnetic permeability □ᵣ. The data were analyzed in accordance with manual for 16454A.

### Cross-Section Inspection Test

A scanning electron microscope (SEM) digital image of a cross-section of the polymer matrix composites were taken with an SEM (obtained under the trade designation “PHENOM” from FEI Company (Hillsboro, Oreg.). The cross-sectional sample was prepared by liquid nitrogen freeze fracturing followed by gold sputter coating with a sputter coater (obtained under the trade designation “EMITECH K550X” from Quorum Technologies (Laughton East Sussex, England).

### Materials

Unless otherwise noted, all parts, percentages, ratios, etc. in the Examples and the rest of the specification are by weight. Solvents and other reagents used may be obtained from Sigma-Aldrich Chemical Company (Milwaukee, Wis.) unless otherwise noted. Table I summarizes the material and source of the materials used in the Examples.

TABLE 1
Raw Materials Used in the Examples

| Abbreviation | Description |
|---|---|
| R1 | Ultrahigh molecular weight polyethylene, UHMWPE GUR |
| | 2126, available from Celanese Corporation (Irving, TX). |
| R2 | Two-part, Pt-catalyzed silicone, 3M ESPE Imprint ™ 3 |
| | Light Body, 3M Company (St. Paul, MN) |
| A1 | Low odor, low aromatic hydrocarbon solvent Isopar G, |
| | available from ExxonMobil Chemical (Houston, TX) |
| F1 | Sendust particles (MATE-SP-82), Mate Co., LTD |
| | (Okayama, Japan) |
| F2 | Boron Nitride Agglomerates, 3M Cooling Fillers |
| | Agglomerates 50M, 3M Company (St. Paul, MN) |

### Formulations

Three different formulation were made from the listed materials. R1, F1, and A1 or A2 were individually weighed according to the formulations summarized in Table 2.

TABLE 2
Formulations Used in the Examples

| Abbreviation | Formulation |
|---|---|
| C1 (One-layer | 4.0 g of R1, 48 g of F1, 48 g of F2, and 105 g of A1 |
| Construction) | |
| C2 (One-layer | Part A: 32.0 g of R2 (yellow component), 8.0 g of F1, |
| Construction) | and 8.0 g of F2 |
| | Part B: 31.5 g of R2 (white component), 8.0 g of F1, |
| | and 8.0 g of F2 |
| C3 (Two-layer | Layer 1: 4.0 g of R1, 46.5 g of F2, and 63.0 g of A1 |
| Construction) | Layer 2: 4.0 g of R1, 46.5 g of F1, and 70.0 g of A3 |

### Procedures

Three different examples were made. Two examples consist of a single layer, which has both particle types (thermally conductive and magnetic particles) mixed together. One example is a two-layer construction, which has each particle type (thermally conductive and magnetic particles) in a separate layer.

The following procedures were used to prepare the Examples.

### Mixing

### Formulation C1

The individual constituents of the formulation were weighted and deposited into a plastic cup (obtained under the trade designation “MAX 300 LONG CUP for a speed mixer obtained under the trade designation “SPEEDMIXER DAC600.2 VAC-LR,” both from FlackTek, Inc. (Landrum, S.C.), which was placed into a SpeedMixer™ (Model DAC 600, FlackTek Inc. (Landrum, S.C.). The mixing was done according to the following profile: 800 RPM for 60 seconds, 1200 RPM for 60 seconds, 800 RPM for 60 seconds, and 0 RPM for 15 seconds while the vacuum was set to 50 mBar for each step.

### Formulation C2

Part A and Part B were separately prepared. The individual components were weighted and deposited into a plastic cup, which was placed into a SpeedMixer™ (Model DAC 600, FlackTek Inc. (Landrum, S.C.). The mixing was done according to the following profile: 800 RPM for 10 seconds, 900 RPM for 20 seconds, and 1200 RPM for 30 seconds while the vacuum was set to 50 mBar for each step.

### Formulation C3

Layer 1 and Layer 2 were prepared separately. The individual components were weighted and deposited into a plastic cup, which was placed into a SpeedMixer™ (Model DAC 600, FlackTek Inc. (Landrum, S.C.). The mixing was done according to the following profile: 800 RPM for 60 seconds, 1200 RPM for 60 seconds, 800 RPM for 60 seconds, and 0 RPM for 15 seconds while the vacuum was set to 50 mBar for each step.

### Illustrative (Co)Polymer Matrix Composite Articles

### Formulation C1

Approximately half of the slurry was deposited onto a 3-mil (75-micrometer) heat stabilized polyethylene terephthalate (PET) liner, then another 3-mil (75-micrometer) PET liner was placed on top to sandwich the slurry. The slurry was spread between the PET liners by using a notch bar set to a gap of 66 mils (1.68 mm). The notch bar rails were wider than the PET liner to obtain an effective wet film thickness of approximately 60 mils (1.52 mm). Progressive multiple passes with increasing downward pressure of the notch bar were used to flatten the slurry.

The sandwiched, formed slurry was placed on an aluminum tray and placed in a lab oven (obtained under the trade designation “DESPATCH RFD1-42-2E” from Despatch, Inc. (Minneapolis, Minn.), at 135° C. (275° F.) for 5 minutes to activate (i.e., to allow the UHMWPE to dissolve into the solvent forming a single phase). After activation, the films were removed from the oven.

The tray with the activated sandwiched, formed slurry was removed from the oven and allowed to air cool to ambient temperature (about 25° C.), forming a solvent filled polymer matrix composite. Both the top and bottom liners were removed, exposing the polymer matrix composite to air. The polymer matrix composite was then placed back on a PET liner on the tray and the tray was inserted into the lab oven at 100° C. (215° F.) for 30 min. After evaporation, the polymer matrix composite was removed from the oven, allowed to cool to ambient temperature, and characterized.

### Formulation C2

Part A and Part B were first mixed together in a plastic cup using a wooden tongue depressor. Subsequently, the plastic cup was placed in the SpeedMixer™ (Model DAC 600, FlackTek Inc. (Landrum, S.C.) once again. The mixer settings were 800 RPM for 30 seconds and the vacuum was set to 50 mBar for each step. The mixture was then deposited on a PET liner and a second PET liner was placed on top to sandwich the mixture. Using a hand-roller and 2 mm spacer bars, the material was compacted and spread to form a sheet, which was cured at room temperature in air for at least 10 minutes before handling.

### Formulation C3

The slurry for layer A was applied to a 3-mil (75-micrometer) heat stabilized polyethylene terephthalate (PET) liner (obtained under the trade designation “COATED PET ROLL #33716020500” from 3M Company (St. Paul, Minn.) with a scoop at room temperature (about 25° C.). Then a 3 mil (75 micrometer) heat stabilized PET liner (“COATED PET ROLL #33716020500”) was applied on top to sandwich the slurry. Two 1 mm thick aluminum sheets were placed between the PET liners along opposite edges, overlapping the PET liners by roughly 0.5 inches. A flat metal bar, long enough to rest on both aluminum sheets, was run over the PET liners to spread the slurry to the 1 mm thickness of the aluminum sheets. Progressive multiple passes with increasing downward pressure of the flat metal bar were used to flatten the slurry.

The aluminum sheets were removed from between the PET liners. The sandwiched, formed slurry was placed on an aluminum tray and placed in a lab oven (obtained under the trade designation “DESPATCH RFD1-42-2E” from Despatch, Inc. (Minneapolis, Minn.), at 135° C. (275° F.) for 5 minutes to activate (i.e., to allow the UHMWPE to dissolve into the solvent forming a single phase). The tray with the activated sandwiched, formed slurry was removed from the oven and allowed to air cool to ambient temperature (about 25° C.), forming a solvent filled polymer matrix composite.

Both the top and bottom liners were removed exposing the polymer matrix composite to air on top. The polymer matrix composite layer A was then placed back on a PET liner (“COATED PET ROLL #33716020500”). The slurry for layer B was applied on top of the activated layer A, then the second PET liner was applied on top of layer B. Four 1 mm thick aluminum sheets were placed between the PET liners along opposite edges (2 sheets per side), overlapping the PET liners by roughly 0.5 inches. A flat metal bar, long enough to rest on both aluminum sheets, was run over the PET liners to spread the slurry layer B to 1 mm thick. Progressive multiple passes with increasing downward pressure of the flat metal bar were used to flatten the slurry.

The aluminum sheets were removed from between the PET liners. The sandwiched, formed slurry was placed on an aluminum tray and placed in a lab oven (obtained under the trade designation “DESPATCH RFD1-42-2E” from Despatch, Inc. (Minneapolis, Minn.), at 135° C. (275° F.) for 5 minutes to activate (i.e., to allow the UHMWPE to dissolve into the solvent forming a single phase). The tray with the activated sandwiched, formed slurry was removed from the oven and allowed to air cool to ambient temperature (about 25° C.), forming a solvent filled polymer matrix composite. Both the top and bottom liners were removed exposing the polymer matrix composite to air on top. The tray was inserted into the lab oven (“DESPATCH RFD1-42-2E”) at 100° C. (215° F.) for an hour. After evaporation, the polymer matrix composite was removed from the oven, allowed to cool to ambient temperature, and characterized.

### Test Results

### Example C1

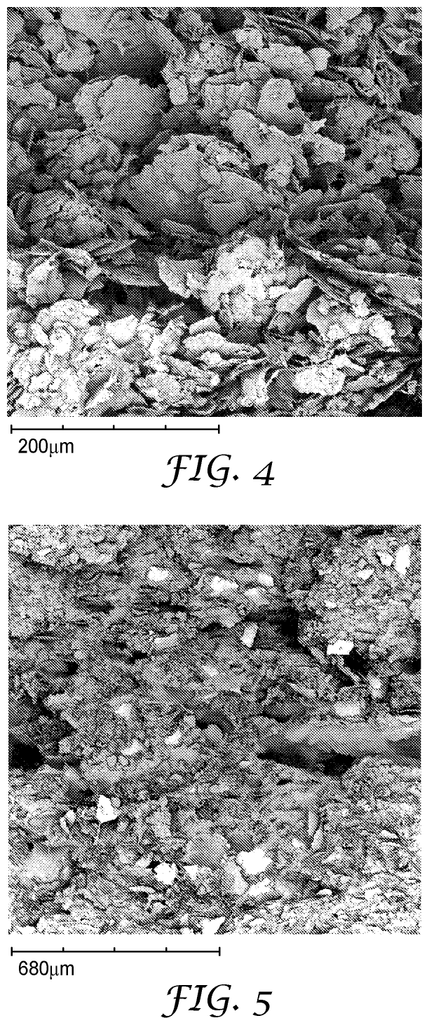

The sample was tested and characterized using the methods described in the “Test Methods” section. The resulting polymer matrix composite was 0.85 mm (33.6 mils) thick and had a measured density of 0.6605 g/cm3 (as determined by the “Density and Porosity Test”), a Gurley air flow of 1.7 sec/50 cm³ (as determined by the “Air Flow Resistance Test”). Referring to FIG. 4, a photomicrograph obtained using the Cross-section Inspection Test on the (co)polymer matrix composite is shown.

### Example C1-B

Example C1-B was prepared as described in Example C1. A 1.5″×1.5″ square was cut from the film. The square was placed between two release liners, and then between two sheet metal plates. This layup was placed in a hydraulic press (obtained under the trade designation “WABASH-GENESIS MODEL G30H-15-LP” from Wabash MPI (Wabash, Ind.) and compressed at 15 tons at ambient temperature (about 25° C.) for 60 seconds. After compression, the sample was tested using the methods described in the sections “Thermal Conductivity Test”, “Magnetic Test I”, and “Magnetic Test II”. The results are summarized in Table 4: for thermal conductivity test and magnetic tests, respectively.

TABLE 3
Sample C1-B Result from Thermal Conductivity Test

| | Measured Thermal | Increase Compared to Polymer |
|---|---|---|
| | Conductivity | Matrix Literature Value (%) |
| Sample ID | (W/m° K) | [UHMWPE = 0.3 W/m° K] |
| C1-B | 1.7 | 466.7 |

TABLE 4
Sample C1-B Results from Magnetic Tests I and II

| Sample ID | Coercivity (Oe) | Permeability (MHz) |
|---|---|---|
| C1-B | 1.7235 | 15.83 |

### Example C2

The sample was tested and characterized using the methods described in the “Test Methods”

section. The resulting polymer matrix composite was 3.23 mm (127.3 mils) thick and had a measured density of 1.583 g/cm3 (as determined by the “Density and Porosity Test”). Error! Reference source not found. shows the SEM image of the example's cross-section. The results for thermal conductivity test and magnetic tests are summarized in Referring to FIG. 5, a photomicrograph obtained using the Cross-section Inspection Test on the (co)polymer matrix composite is shown.

Table 5 respectively. Referring to FIG. 5, a photomicrograph obtained using the Cross-section Inspection Test on the (co)polymer matrix composite is shown.

TABLE 5
Sample C1-B Result from Thermal Conductivity Test

| | Measured Thermal | Increase Compared to Polymer |
|---|---|---|
| | Conductivity | Matrix Literature Value (%) |
| Sample ID | (W/m° K) | [UHMWPE = 0.3 W/m° K] |
| C2 | 0.803 | 301.5 |

TABLE 6
Sample C1-B Results from Magnetic Tests I and II

| Sample ID | Coercivity (Oe) | Permeability (MHz) |
|---|---|---|
| C2 | 0.859 | 3.549 |

### Example C3

The sample was tested and characterized using the methods described in the “Test Methods” section. The resulting polymer matrix composite was 1.63 mm (64.3 mils) thick and had a measured density of 0.654 g/cm3 (as determined by the “Density and Porosity Test”).

### Example C3-B

Example C3-B was prepared as described in Example C3. A 1.5″×1.5″ square was cut from the film. The square was placed between two release liners, and then between two sheet metal plates. This layup was placed in a hydraulic press (obtained under the trade designation “WABASH-GENESIS MODEL G30H-15-LP” from Wabash MPI (Wabash, Ind.) and compressed at 15 tons at ambient temperature (about 25° C.) for 60 seconds. After compression, the sample was tested using the methods described in the sections “Thermal Conductivity Test”, “Magnetic Test I”, and “Magnetic Test II”. The results are summarized in

Table 7: and 8, respectively.

TABLE 7
Sample C3-B Results from Thermal Conductivity Test

| | Measured Thermal | Increase Compared to Polymer |
|---|---|---|
| | Conductivity | Matrix Literature Value (%) |
| Sample ID | (W/m° K) | [UHMWPE = 0.3 W/m° K] |
| C3-B | 1.12 | 273.3 |

TABLE 8
Sample C3-B Results from Magnetic Tests I and II

| Sample ID | Coercivity (Oe) | Permeability (MHz) |
|---|---|---|
| C3-B | 1.276 | 37.601 |

Reference throughout this specification to “one embodiment,” “certain embodiments,” “one or more embodiments” or “an embodiment,” whether or not including the term “exemplary” preceding the term “embodiment,” means that a particular feature, structure, material, or characteristic described in connection with the embodiment is included in at least one embodiment of the certain exemplary embodiments of the present disclosure. Thus, the appearances of the phrases such as “in one or more embodiments,” “in certain embodiments,” “in one embodiment” or “in an embodiment” in various places throughout this specification are not necessarily referring to the same embodiment of the certain exemplary embodiments of the present disclosure. Furthermore, the particular features, structures, materials, or characteristics may be combined in any suitable manner in one or more embodiments.

While the specification has described in detail certain exemplary embodiments, it will be appreciated that those skilled in the art, upon attaining an understanding of the foregoing, may readily conceive of alterations to, variations of, and equivalents to these embodiments. Accordingly, it should be understood that this disclosure is not to be unduly limited to the illustrative embodiments set forth hereinabove. In particular, as used herein, the recitation of numerical ranges by endpoints is intended to include all numbers subsumed within that range (e.g., 1 to 5 includes 1, 1.5, 2, 2.75, 3, 3.80, 4, and 5). In addition, all numbers used herein are assumed to be modified by the term “about.”

Furthermore, all publications and patents referenced herein are incorporated by reference in their entirety to the same extent as if each individual publication or patent was specifically and individually indicated to be incorporated by reference. Various exemplary embodiments have been described. These and other embodiments are within the scope of the following claims.

What is claimed is:

1. A (co)polymer matrix composite comprising:
a porous (co)polymeric network structure; and
a plurality of thermally-conductive particles and a plurality of magnetic particles distributed within the (co)polymeric network structure,
wherein the thermally-conductive particles, magnetic particles, and optional magnetic particles are present in a range from 15 to 99 weight percent of the (co)polymer matrix composite.

2. The (co)polymer matrix composite of claim 1, wherein the (co)polymer matrix composite has a density of at least 0.3 g/cm³, or a porosity of at least 5 percent.

3. The (co)polymer matrix composite of claim 1, wherein the thermally-conductive particles comprise at least one of electrically non-conductive particles or electrically-conductive particles, further wherein the electrically non-conductive particles are ceramic particles selected from the group consisting of boron nitride, aluminum trihydrate, silicon carbide, silicon nitride, metal oxides, metal nitrides, and combinations thereof, and the electrically-conductive particles are metal particles selected from the group consisting of aluminum, copper, nickel, silver, platinum, gold, and combinations thereof, additionally wherein the magnetic particles comprise at least one of Fe-based amorphous nitrides, Fe-based nanocrystalline nitrides, Fe-based nanocrystalline nitrides, Fe—Al—Si, Fe—Cr, Fe—Si, Fe—Si—B, Fe—Si—Cr, Fe—Co—B, Ni—Fe, Ni—Fe—Mo, Ni—Si, Co—Nb—Zr, boron based amorphous alloys; iron oxide, Ni—Zn, Mn—Zn; Fe—Cr—Co, Nd—Fe—B, Sm—Co, Sm—Fe—N, Al—Ni—Co, Cu—Ni—Fe, Cu—Ni—Fe—Co, steel with a ferritic or martensitic crystal structure, barium ferrite, strontium ferrite, and combinations thereof.

4. The (co)polymer matrix composite of claim 1, wherein the porous (co)polymeric network structure comprises at least one of polyurethane, polyester, polyamide, polyether, polycarbonate, polyimide, polysulfone, polyethersulfone, polyphenylene oxide, polyacrylate, poly(meth)acrylate, polyacrylonitrile, polyolefin, styrene or styrene-based random and block (co)polymer, chlorinated (co)polymer, fluorinated (co)polymer, or (co)polymers of ethylene and chlorotrifluoroethylene.

5. The (co)polymer matrix composite of claim 1, wherein the thermally-conductive particles and the magnetic particles are present in a single layer.

6. The (co)polymer matrix composite of claim 1, wherein the thermally-conductive particles and the magnetic particles are present in a plurality of layers.

7. The (co)polymer matrix composite of claim 1, wherein the thermally-conductive particles are present in a first layer, and the magnetic particles are present in a second layer adjacent to the first layer, optionally wherein the second layer adjoins the first layer.

8. The (co)polymer matrix composite of claim 1, wherein the thermally-conductive particles are present in a first layer having opposed first and second major surfaces, and the magnetic particles are present in a second layer overlaying and adjacent to the first major surface of the first layer, and a third layer overlaying and adjacent to the second major surface of the first layer, optionally wherein the second layer adjoins the first major surface, and the third layer adjoins the second major surface.

9. A method of making the (co)polymer matrix composite of claim 1, the method comprising:
combining a thermoplastic (co)polymer, a solvent, a plurality of thermally-conductive particles, and a plurality of magnetic particles to provide a slurry;
forming the slurry in to an article;
heating the article in an environment to retain at least 90 percent by weight of the solvent in the article, based on the weight of the solvent in the article, and solubilize at least 50 by weight percent of the thermoplastic (co)polymer, based on the total weight of the thermoplastic (co)polymer; and
inducing phase separation of the thermoplastic (co)polymer from the solvent to provide the (co)polymer matrix composite.

10. The method of claim 9, further comprising removing at least a portion of the solvent from the formed article after inducing phase separation of the thermoplastic (co)polymer from the solvent.

11. The method of claim 10, wherein no solvent is removed from the formed article.

12. The method of claim 9, wherein the (co)polymer in the slurry has a melting point, wherein the solvent has a boiling point, and wherein combining is conducted below the melting point of the (co)polymer in the slurry, and below the boiling point of the solvent.

13. The method of claim 9, wherein the (co)polymer in the slurry has a melting point, and wherein inducing phase separation is conducted at less than the melting point of the (co)polymer in the slurry.

14. The method of claim 9, further comprising compressing the (co)polymer matrix composite by applying a compressive force, and optionally applying vibratory energy to the (co)polymer matrix composite simultaneously with the applying of the compressive force.

15. A method of making the (co)polymer matrix composite of claim 1, the method comprising:
combining a thermoplastic (co)polymer, a solvent for the thermoplastic (co)polymer, a plurality of thermally-conductive particles and a plurality of magnetic particles to form a suspension of magnetic particles in a miscible thermoplastic (co)polymer-solvent solution;
inducing phase separation of the thermoplastic (co)polymer from the solvent; and
removing at least a portion of the solvent to provide the (co)polymer matrix composite.

16. The method of claim 15, wherein inducing phase separation includes at least one of thermally induced phase separation or solvent induced phase separation.

17. The method of claim 15, wherein the (co)polymer in the miscible thermoplastic (co)polymer-solvent solution has a melting point, wherein the solvent has a boiling point, and wherein combining is conducted above the melting point of the miscible thermoplastic (co)polymer-solvent solution, and below the boiling point of the solvent.

18. The method of claim 15, wherein the (co)polymer in the miscible thermoplastic (co)polymer-solvent solution has a melting point, and wherein inducing phase separation is conducted at less than the melting point of the (co)polymer in the miscible thermoplastic (co)polymer-solvent solution.

19. The method of claim 9, further comprising compressing the (co)polymer matrix composite by applying a compressive force, and optionally applying vibratory energy to the (co)polymer matrix composite simultaneously with the applying of the compressive force.

20. An article comprising the (co)polymer matrix composite of claim 1, optionally wherein the article is an electronic device.
